(19) United States
(12) Patent Application Publication
(10) Pub. No.: US 2008/0228365 A1
(43) Pub. Date: Sep. 18, 2008

(54) VEHICLE POWER INHIBITER

(76) Inventors: Steven C. White, La Quinta, CA (US); Roger F. Wells, Anaheim Hills, CA (US)

Correspondence Address: CHRISTIE, PARKER & HALE, LLP, PO BOX 7068, PASADENA, CA, 91109-7068, US

(21) Appl. No.: 11/696,690

(22) Filed: Apr. 4, 2007

Related U.S. Application Data
(60) Provisional application No. 60/789,822, filed on Apr. 5, 2006.

(51) Int. Cl. G06F 19/00; G06F 7/00

(52) U.S. Cl. 701/70; 701/36

(57) ABSTRACT

A method and system for inhibiting power of a vehicle given to a third party. The system includes a mode-indicating, an authenticator coupled to the mode-indicating device, and a power inhibiting device coupled to the mode-indicating device and adapted to selectively inhibit the power of the vehicle. Here, the mode-indicating device is adapted to communicate a power restriction signal to the power inhibiting device to inhibit the power of the vehicle upon an activation of the mode-indicating device by an authenticated driver and until a deactivation of the mode-indicating device by the authenticated driver, and the authenticator is adapted to restrict the activation and the deactivation of the mode-indicating device unless the driver has been authenticated by the authenticator.

### CROSS-REFERENCE TO RELATED APPLICATION(S)

This application claims priority to and the benefit of U.S. Provisional Application No. 60/789,822, filed on Apr. 5, 2006, the entire content of which is incorporated herein by reference.

### FIELD OF THE INVENTION

The present invention relates to method and system for inhibiting power of a vehicle.

### BACKGROUND OF THE INVENTION

The operation of a vehicle normally requires only a key. Anti-theft devices exist which add security based on a pass code. More advanced anti-theft devices exist to disable vehicles if biometric authentication, such as a fingerprint scan, is unsuccessful. However, vehicle control systems are severely lacking in a variety of aspects.

For example, U.S. Pat. No. 5,586,457, which is herein incorporated by reference, discloses an accelerator pedal obstruction device located beneath an accelerator pedal that prevents and deters unauthorized use of a vehicle by limiting the vehicle to idle speed. Accelerator pedal obstructing devices consequently limit a vehicle's engine rotational speed or revolutions per minute (“RPM”), such that the device operates as an anti-theft device.

While accelerator pedal obstructing devices are generally known in the prior art, there is a need for an accelerator pedal obstruction device with an improved obstructing mechanism and a corresponding safety release mechanism. Furthermore, there is a need for a vehicle power inhibiter with an obstruction mechanism that functions without obstructing the accelerator pedal.

In addition, there is a need for a vehicle power inhibiter to block (or prevent) third parties, such as valets, from revving the vehicle's engine or moving the vehicle at velocities beyond which is required to park a vehicle.

### SUMMARY OF THE INVENTION

An aspect of an embodiment of the present invention provides a method and system for inhibiting a power of a vehicle given to a third party (e.g., a valet).

An embodiment of the present invention provides a system for inhibiting power of a vehicle given to a third party. The system includes a system controller; a mode-indicating device coupled to the system controller; an authenticator coupled to the system controller; and a power inhibiting device coupled to the system controller and adapted to selectively inhibit the power of the vehicle. Here, the system controller is adapted to communicate a power restriction signal to the power inhibiting device to inhibit the power of the vehicle upon an activation of the mode-indicating device by an authenticated driver and until a deactivation of the mode-indicating device by the authenticated driver, and the system controller is further adapted to restrict the activation and the deactivation of the mode-indicating device unless the driver has been authenticated by the authenticator.

Another embodiment of the present invention provides a system for inhibiting power of a vehicle given to a third party. The system includes a system controller; a mode-indicating device coupled to the system controller; an authenticator coupled to the system controller; and a power inhibiting device coupled to the system controller and adapted to selectively inhibit the power of the vehicle. Here, the system controller is adapted to communicate a power restriction signal to the power inhibiting device to mechanically inhibit the power of the vehicle upon an activation of the mode-indicating device by an authenticated driver and until a deactivation of the mode-indicating device by the authenticated driver, and the system controller is further adapted to restrict the activation and the deactivation of the mode-indicating device unless the driver has been authenticated by the authenticator.

In one embodiment, the power inhibiting device includes a rotating cam plate fitted below an accelerator pedal of the vehicle and adapted to operate through a slot in a floor pan of the vehicle; and a motor adapted to selectively drive the rotating cam plate to a first position to block a travel of the accelerator pedal to a first power level and a second position to unblock the travel of the accelerator pedal. The motor may be further adapted to selectively drive the rotating cam plate to a third position to block a travel of the accelerator pedal to a second power level, and the second power level may higher in power than the first power level and lower in power than a full power level. The power inhibiting device may include a first stop pin adapted to selectively move between a stopping position and a release position, the stopping position of the first stop pin being adapted to block the rotating cam plate from moving toward the second position from the first position; and a second stop pin adapted to selectively move between a stopping position and a release position, the stopping position of the second stop pin being adapted to block the rotating cam plate from moving toward the second position from the third position. The power inhibiting device may include a stop pin adapted to selectively move between a stopping position and a release position, the stopping position of the stop pin being adapted to block the rotating cam plate from moving toward the second position from the first position.

In one embodiment, the power inhibiting device includes an inhibiting pin; a split collet adapted to hold the inhibiting pin; and a motor fitted to an underside of a floor pan of the vehicle and adapted to raise the inhibiting pin with the split collet through a hole in the floor pan of the vehicle to selectively block a travel of the accelerator pedal. The split collet may be adapted to be disconnected from the inhibiting pin to unblock the travel of the accelerator pedal upon the deactivation of the mode-indicating device. The split collet may be a solenoid actuated split threaded collet. The inhibiting pin may have a multi-start thread. The inhibiting pin may have a square thread. The motor may be adapted to turn the inhibiting pin to control a position of rise of the inhibiting pin and a power level of the vehicle.

In one embodiment, the power inhibiting device includes a lever extended from a throttle arm and adapted to selectively limit a rotary travel of the throttle arm to limit an air supply to limit a demand to increase the power of the vehicle; and a retractable pin adapted to selectively move between a stopping position and a release position, the stopping position of the retractable pin being adapted to limit a rotary travel of the lever. The power inhibiting device may further include an overload protection device coupled between the throttle arm and an actuator cable adapted to drive the throttle arm. The overload protection device may include an overload protection spring.

In one embodiment, the power inhibiting device includes a lever extended from a throttle arm and adapted to selectively limit a rotary travel of the throttle arm to limit a demand to increase the power of the vehicle; a first retractable pin adapted to selectively move between a stopping position and a release position, the stopping position of the first retractable pin being adapted to limit a rotary travel of the lever to a first lever position to limit the rotary travel of the throttle arm to a first throttle arm position to limit the demand to increase the power of the vehicle to a first power level; and a second retractable pin adapted to selectively move between a stopping position and a release position, the stopping position of the second retractable pin being adapted to limit the rotary travel of the lever to a second lever position to limit the rotary travel of the throttle arm to a second throttle arm position to limit the demand to increase the power of the vehicle to a second power level. The second power level may be higher in power than the first power level and lower in power than a full power level.

In one embodiment, the power inhibiting device includes a control arm coupled to a linear lever of a fuel injection pump and adapted to selectively limit a travel of the linear lever to limit a fuel supply to limit a demand to increase the power of the vehicle; and a retractable pin adapted to selectively move between a stopping position and a release position, the stopping position of the retractable pin being adapted to limit a travel of the control arm. The fuel injection pump may be adapted to provide fuel to a diesel engine.

In one embodiment, the power inhibiting device includes a control arm coupled to a linear lever of a fuel injection pump and adapted to selectively limit a travel of the linear lever to limit a demand to increase the power of the vehicle; a first retractable pin adapted to selectively move between a stopping position and a release position, the stopping position of the first retractable pin being adapted to limit a travel of the control arm to a first arm position to limit the travel of the linear lever to a first lever position to limit the demand to increase the power of the vehicle to a first power level; and a second retractable pin adapted to selectively move between a stopping position and a release position, the stopping position of the second retractable pin being adapted to limit the travel of the control arm to a second arm position to limit the travel of the linear lever to a second lever position to limit the demand to increase the power of the vehicle to a second power level.

Another embodiment of the present invention provides a system for inhibiting power of a vehicle given to a third party. The system includes a mode-indicating device; and a power inhibiting device coupled to the mode-indicating device and adapted to selectively inhibit the power of the vehicle. The power inhibiting devices includes a rotating cam plate fitted below an accelerator pedal of the vehicle and adapted to operate through a slot in a floor pan of the vehicle; and a motor adapted to selectively drive the rotating cam plate to a first position to block a travel of the accelerator pedal to a first power level and a second position to unblock the travel of the accelerator pedal. Here, the mode-indicating device is adapted to communicate a power restriction signal to the power inhibiting device to inhibit the power of the vehicle upon an activation of the mode-indicating device by a driver and until a deactivation of the mode-indicating device by the driver.

Another embodiment of the present invention provides a system for inhibiting power of a vehicle given to a third party. The system includes a mode-indicating device; and a power inhibiting device coupled to the mode-indicating device and adapted to selectively inhibit the power of the vehicle. The power inhibiting devices includes an inhibiting pin; a split collet adapted to hold the inhibiting pin; and a motor fitted to an underside of a floor pan of the vehicle and adapted to raise the inhibiting pin with the split collet through a hole in the floor pan of the vehicle to selectively block a travel of the accelerator pedal. Here, the mode-indicating device is adapted to communicate a power restriction signal to the power inhibiting device to inhibit the power of the vehicle upon an activation of the mode-indicating device by a driver and until a deactivation of the mode-indicating device by the driver.

Another embodiment of the present invention provides a system for inhibiting power of a vehicle given to a third party. The system includes a mode-indicating device coupled to the system controller; and a power inhibiting device coupled to the mode-indicating device and adapted to selectively inhibit the power of the vehicle. The power inhibiting device includes a lever extended from a throttle arm and adapted to selectively limit a rotary travel of the throttle arm to limit an air supply to limit a demand to increase the power of the vehicle; and a retractable pin adapted to selectively move between a stopping position and a release position, the stopping position of the retractable pin being adapted to limit a rotary travel of the lever. Here, the mode-indicating device is adapted to communicate a power restriction signal to the power inhibiting device to inhibit the power of the vehicle upon an activation of the mode-indicating device by a driver and until a deactivation of the mode-indicating device by the driver.

Another embodiment of the present invention provides a system for inhibiting power of a vehicle given to a third party. The system includes a mode-indicating device; an authenticator coupled to the mode-indicating device; and a power inhibiting device coupled to the mode-indicating device and adapted to selectively inhibit the power of the vehicle. Here, the mode-indicating device is adapted to communicate a power restriction signal to the power inhibiting device to mechanically inhibit the power of the vehicle upon an activation of the mode-indicating device by an authenticated driver and until a deactivation of the mode-indicating device by the authenticated driver, and the authenticator is adapted to restrict the activation and the deactivation of the mode-indicating device unless the driver has been authenticated by the authenticator.

In one embodiment, the power inhibiting device includes an obstructing member having a rotating pin and being adapted to rotate from a non-obstructing position to an obstructing position to limit power of a vehicle and to rotate from the obstructing position to the non-obstructing position to allow an increase of power to a vehicle; a base member including a motor for rotating a gear along an inner pathway of the base member; and a rod having a rod first end and a rod second end, the rod being adapted to rotate the obstructing member to the non-obstructing position and the obstructing position, the rod being connected to the rotating pin of the obstructing member at the rod first end and to the gear at the rod second end. Here, the obstructing member is coupled to the base member and the motor is adapted to rotate the gear, the gear and the rod second end are adapted to move along the inner pathway of the base member as the gear is rotated such that the obstructing member is rotated to the obstructing position or the non-obstructing position. In addition, the inner pathway of the base member may be a straight pathway.

In one embodiment, the power inhibiting device includes an obstructing member having a shaft and being adapted to rotate with respect to the shaft from a non-obstructing position to an obstructing position to limit power of a vehicle and to rotate from the obstructing position to the non-obstructing position to allow an increase of power to a vehicle; a base member having a connecting member connected to the shaft and including a motor adapted to turn the shaft; and a rod for supporting the obstructing member having a rod first end and a rod second end, the rod first end being connected to the obstructing member at a distal end from the shaft, the rod second end being located within an inner pathway of the base member. Here, as the motor rotates the shaft, the obstructing member is rotated with respect to the shaft to the obstructing position or the non-obstructing position. In addition, the inner pathway of the base member may include teeth that are extended when the obstructing member is rotated to an obstructing position and are retracted when the obstructing member is rotated to a non-obstructing position. The inner pathway of the base member may also include teeth that are extended when the obstructing member is rotated to an obstructing position and are retracted when the power inhibiting device loses power. The motor may rotate a belt, and the belt may rotate the shaft. The inner pathway of the base member may be an arcuate pathway.

In one embodiment, the power inhibiting device includes an obstructing member having a shaft and being adapted to rotate with respect to the shaft from a non-obstructing position to an obstructing position to limit power of a vehicle and to rotate from the obstructing position to the non-obstructing position to allow an increase of power to a vehicle; a base member having a connecting member connected to the shaft and including a motor adapted to turn the shaft; and a rod for supporting the obstructing member having a rod first end and a rod second end, the rod first end being connected to the base member at a distal end from the motor, the rod second end being located within an inner pathway of the obstructing member. Here, as the motor turns the shaft, the obstructing member is rotated with respect to the shaft to the obstructing position or the non-obstructing position. In addition, the inner pathway of the obstructing member may include teeth that are extended when the obstructing member is rotated to an obstructing position and are retracted when the obstructing member is rotated to a non-obstructing position. The inner pathway of the obstructing member may also include teeth that are extended when the obstructing member is rotated to an obstructing position and are retracted when the power inhibiting device loses power. The motor may rotates a belt, and the belt may rotate the shaft. The inner pathway of the obstructing member may be an arcuate pathway.

In one embodiment, the authenticator includes a biometric authenticator selected from the group consisting of a fingerprint authenticator, a face recognition authenticator, a hand-geometry authenticator, a voice authenticator, and combinations thereof.

In one embodiment, the authenticator includes a fingerprint sensor.

In one embodiment, the power inhibiting device includes an obstructing member adapted to move between at least obstructing position to block a demand to increase power of the vehicle and a clearing position to unblock the demand to increase power; and a moving member adapted to selectively move the obstructing member to the at least one obstructing position and the clearing position. The power inhibiting device may also include a locking member adapted to selectively move between a locking position and a release position, the locking position of the locking member being adapted to block the obstructing member from moving toward the clearing position from the at least one obstructing position.

In one embodiment, the power inhibiting device includes an obstructing member adapted to move between a first obstructing position to block a demand to increase power of the vehicle to a first power level, a second obstructing position to block a demand to increase power to a second power level, and a clearing position to unblock the demand to increase power; and a moving member adapted to selectively move the obstructing member to the first obstructing position, the second obstructing position, and the clearing position. Here, the second power level is higher in power than the first power level and lower in power than a full power level.

In one embodiment, the system for inhibiting power of the vehicle given to the third party further includes a substance detecting device coupled to the system controller and adapted to provide a substance level in the third party to the system controller.

In one embodiment, the third party is a valet.

In one embodiment, the power inhibiting device is adapted to limit a demand to increase the power of the vehicle.

In one embodiment, the system for inhibiting power of the vehicle given to the third party further includes a system controller coupled to the mode-indicating device, the authenticator, and the power inhibiting device. Here, the mode-indicating device is adapted to communicate the power restriction signal to the power inhibiting device via the system controller, and the authenticator is adapted to restrict the activation and the deactivation of the mode-indicating device unless the driver has been authenticated by the authenticator via the system controller.

Another embodiment of the present invention provides a system for inhibiting power of a vehicle given to a third party. The system includes a mode-indicating device; an authenticator coupled to the mode-indicating device; and a power inhibiting device coupled to the mode-indicating device and adapted to selectively inhibit the power of the vehicle. Here, the mode-indicating device is adapted to communicate a power restriction signal to the power inhibiting device to electronically inhibit the power of the vehicle upon an activation of the mode-indicating device by an authenticated driver and until a deactivation of the mode-indicating device by the authenticated driver, and the authenticator is adapted to restrict the activation and the deactivation of the mode-indicating device unless the driver has been authenticated by the authenticator.

In one embodiment, the power inhibiting device includes a voltage control circuit adapted to switch between a first part of the voltage control circuit adapted to supply an electronic control unit (ECU) of the vehicle with a voltage to increase the power of the vehicle when the voltage is less than a set voltage and with the set voltage when the transducer voltage is greater than or equal to the set voltage and a second part of the voltage control circuit adapted to supply the ECU of the vehicle with the voltage to increase the power of the vehicle. the voltage control circuit may be electrically coupled between the ECU of the vehicle and a transducer of an accelerator of the vehicle. The first part of the voltage control circuit may include a first voltage limiter to limit a voltage to a first voltage limit and a second voltage limiter to limit a voltage to a second voltage limit. The first voltage limit may be adapted to limit the vehicle to be in an idle mode, and the second voltage limit may be adapted to limit the vehicle to be in a valet mode. Alternatively, the first part of the voltage control circuit may include a first power limiter to limit the power of the vehicle to a first power level and a second power limiter to limit the power of the vehicle to a second power level. The second power level may be higher in power than the first power level and lower in power than a full power level.

In one embodiment, the authenticator includes a biometric authenticator selected from the group consisting of a fingerprint authenticator, a face recognition authenticator, a hand-geometry authenticator, a voice authenticator, and combinations thereof.

In one embodiment, the authenticator comprises a fingerprint sensor.

In one embodiment, the system for inhibiting power of the vehicle given to the third party further includes a substance detecting device coupled to the system controller and adapted to provide a substance level in the third party to the system controller.

In one embodiment, the third party is a valet.

In one embodiment, the power inhibiting device is adapted to limit a demand to increase the power of the vehicle.

In one embodiment, the system for inhibiting power of the vehicle given to the third party further includes a system controller coupled to the mode-indicating device, the authenticator, and the power inhibiting device. Here, the mode-indicating device is adapted to communicate the power restriction signal to the power inhibiting device via the system controller, and the authenticator is adapted to restrict the activation and the deactivation of the mode-indicating device unless the driver has been authenticated by the authenticator via the system controller.

Another embodiment of the present invention provides a method of limiting power of a vehicle having a drive-by-wire system. The method includes: allowing a user to control a first mode of operation of the drive-by-wire system and a second mode of operation of the drive-by-wire system; supplying an electronic circuit with a transducer voltage in the first mode of operation; and supplying the electronic circuit with the transducer voltage when the transducer voltage is less than a set voltage and with the set voltage when the transducer voltage is greater than or equal to the set voltage in the second mode of operation.

In one embodiment, the method further includes: allowing the user to control a third mode of operation of the drive-by-wire system; and supplying the electronic circuit with an idle voltage in the third mode of operation.

In one embodiment, the electronic circuit may be an electronic control unit (ECU) of the vehicle.

Another embodiment of the present invention provides a system for inhibiting power of a vehicle given to a third party. The system includes a mode-indicating device; and a power inhibiting device coupled to the mode-indicating device and adapted to selectively inhibit the power of the vehicle, the power inhibiting device comprising a voltage control circuit adapted to switch between a first part of the voltage control circuit adapted to supply an electronic control unit (ECU) of the vehicle with a voltage to increase the power of the vehicle when the voltage is less than a set voltage and with the set voltage when the transducer voltage is greater than or equal to the set voltage and a second part of the voltage control circuit adapted to supply the ECU of the vehicle with the voltage to increase the power of the vehicle. Here, the mode-indicating device is adapted to communicate a power restriction signal to the power inhibiting device to inhibit the power of the vehicle upon an activation of the mode-indicating device by a driver and until a deactivation of the mode-indicating device by the driver.

In one embodiment, the voltage control circuit is electrically coupled between the ECU of the vehicle and a transducer of an accelerator of the vehicle. The first part of the voltage control circuit may include a first voltage limiter to limit a voltage to a first voltage limit and a second voltage limiter to limit a voltage to a second voltage limit. The first voltage limit may be adapted to limit the vehicle to be in an idle mode, and the second voltage limit may be adapted to limit the vehicle to be in a valet mode. Alternatively, the first part of the voltage control circuit may include a first power limiter to limit the power of the vehicle to a first power level and a second power limiter to limit the power of the vehicle to a second power level. The second power level may be higher in power than the first power level and lower in power than a full power level.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 shows a block diagram of a driver's card identification system and/or a system of preventing use (or unauthorized use) of a vehicle by an operator (or driver) of the vehicle pursuant to aspects of an embodiment of the present invention.

FIG. 2 shows a flowchart of process blocks associated with a driver's card identification system and/or a system of preventing use (or unauthorized use) of a vehicle by an operator (or driver) of the vehicle pursuant to aspects of an embodiment of the present invention.

FIG. 3 shows a block diagram of an enhanced biometric and substance detection system and device pursuant to aspects of an embodiment of the present invention.

FIG. 4 shows a block diagram of a vehicle including the enhanced biometric and substance detection system and device of FIG. 3 pursuant to aspects of an embodiment of the present invention.

FIG. 5 shows a block diagram of a system for inhibiting a power of a vehicle given to a third party, for in-vivo measurement of a concentration of a substance in a tissue of a person, and/or for preventing use of a vehicle by an operator of the vehicle pursuant to aspects of an embodiment of the present invention.

FIGS. 6, 7, and 8 show flowcharts of process blocks of system logics for inhibiting a power of a vehicle given to a third party, for in-vivo measurement of a concentration of a substance in a tissue of a person, and/or for preventing use of a vehicle by an operator of the vehicle pursuant to aspects of an embodiment of the present invention.

FIG. 9 is a view of a conventional accelerator pedal.

FIG. 10 is a view of an accelerator pedal vehicle power inhibiter implemented by a motor-actuated screw mechanism according to an exemplary embodiment of the present invention.

FIG. 11 is an internal view of the vehicle power inhibiter depicted in FIG. 10.

FIG. 12 is a view of a solenoid vehicle power inhibiter according to an exemplary embodiment of the present invention.

FIG. 13 is a view of a moving coil vehicle power inhibiter according to an exemplary embodiment of the present invention.

FIG. 14 is a view of a rotating cam vehicle power inhibiter according to an exemplary embodiment of the present invention.

FIG. 15 is a view of a rotating cam vehicle power inhibiter according to another exemplary embodiment of the present invention.

FIG. 16 is a view of a cable driven throttle with an overload protection spring according to an exemplary embodiment of the present invention.

FIG. 17 is a view of a vehicle power inhibiter for cable driven throttles according to an exemplary embodiment of the present invention.

FIG. 18 is a block diagram of a vehicle power inhibiter system for diesel powered vehicles according to an exemplary embodiment of the present invention.

FIG. 19 is a block diagram of a vehicle power inhibiter system for a drive-by-wire system according to an exemplary embodiment of the present invention.

FIG. 20 is a circuit diagram of a vehicle power inhibiter system for the drive-by-wire system of FIG. 19.

FIG. 21, FIG. 22, and FIG. 23 are views of vehicle power inhibiter systems according to further exemplary embodiments of the present invention.

### DETAILED DESCRIPTION

In the following detailed description, only certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, and not restrictive.

As envisioned in an embodiment of the present invention, a system provides theft protection, assures compliance with driving and/or licensing laws, offers customizable control for use by parents or when a vehicle is given to a third party such as a valet, service facility, designated driver, friend, or employee. The system further provides secure, encrypted, verifiable statistical information about a person's driving habits and who was driving at a particular time. The system may further restrict the driving of vehicles while under the influence of alcohol or drugs.

One embodiment of the present invention envisions a system that blocks or prevents unauthorized use of a vehicle by using biometrics coupled with verifiable credentials. This may be accomplished by requiring a biometric verification, such as an iris scan, retinal scan, fingerprint scan, face recognition scan, hand-geometry scan, or voice authentication in combination with a verifiable credential. A verifiable credential may be a driver's license with barcode, magnetic stripe, an RFID, a smartcard, a credit card, a key ring including an infrared adapter, an under-skin implant, or other credential issued by a trusted source. Such a system could further include adjusting the requirements to start or drive the vehicle based on the time of day, day of week, number of hours driven in a particular time period, driving conditions, location, number of passengers or their status, government-issued alert status, or planned route or destination. Such a system may be implemented in a variety of ways. One implementation is through the use of a software and hardware-based tamper-proof control module (or system controller) that accepts as inputs a biometric authenticator, and a credential-reader. The control module may include or be connected to a database either in the vehicle or through a wireless connection. The control module can verify that the biometric authentication matches the verifiable credentials and that the credentials and/or authentication is valid. Based on the results of the verification, the control module may communicate with the vehicle computer to permit the vehicle to start or to communicate driving restrictions including those received from the database or wireless connection. The control module may also report an error or request additional credentials based on the verification, information from the database, or information from the wireless connection.

Another embodiment of the present invention envisions a system that blocks or prevents unauthorized use of a vehicle by using biometrics and/or verifiable credentials coupled with a detection system for alcohol or drugs. Such a system could include requiring a particular driver or class of drivers to pass a breathalyzer test based on their biometric scan and/or use information obtained from the biometric identification to restrict the use of the vehicle. For example, retinal scanners may identify that a person is under the influence of alcohol or drugs because the scanned retinal pattern or blood vessel pattern is different for a person under the influence of alcohol and certain drugs as compared to that same person when not under the influence. Further, a pupil dilation test may be performed to determine intoxication by measuring the speed and extent that the pupil dilates when a beam of light is flashed at the eye. This change in retinal pattern or pupil dilation may be quantifiable or measured as a percent of deviation from the expected pattern. If the deviation exceeds a tolerance, then the vehicle may be restricted or may require an alternate form of verification such as a call to an operator, visit from a police officer, or an alternate proof of sobriety such as a breathalyzer. For example, if a driver who is under the influence of alcohol attempts to verify his identity using a retinal scan, a flag in the system could be activated requiring him to prove that he is not drunk (such as by notifying a police officer or family member via wireless communications) or disabling the vehicle or limiting his speed or route. Such a coupling of biometrics with substance detection is beneficial since it allows different detection thresholds and responses to be set for different individuals. It also reduces the likelihood that a friend or passenger could fool a standard ignition lockout breathalyzer device by blowing into it then letting the intoxicated driver drive. Tolerances could be controlled from state-to-state or customized to a particular driver by storing the tolerance level in their credentials. Customization of tolerance levels could allow particular drivers to be authorized to drive if their scan differentiation exceeds certain percentages, such as an elderly person whose eyes may be changing. If an alternate proof is provided, such as an override code from a police officer, any information about that code would be stored in a log, such as the overriding officer's badge number.

Another embodiment of the present invention envisions a system that allows for control of a vehicle given to a third party. A third party may include a valet, service facility, designated driver, friend, or employee. The vehicle may be configured to operate in a restricted capacity, such as by limiting its power, speed, acceleration, number of minutes or miles it can travel, gears that it can shift, locations that it can go, accessories that can be activated, or compartments that may be opened. A time-delayed valet button or system may be activated to engage the restrictions until an authorized (or authenticated) driver retakes control of the vehicle or a proper non-valet key is used. A valet may not be required to perform a biometric identification, but access to the vehicle would be restricted. A valet option may also include a limited number of additional starts, so that the valet has the ability to move the car if needed. If the valet attempts to exceed the number of starts or other restrictions the vehicle can create an alert and optionally notify a designated individual remotely, such as by sending an SMS message to a cell phone. When such a system is engaged a sound may be emitted or a visual alert provided. The system may also be optionally reset by the use of a pin number or password. This aspect may be coupled with biometric identification and/or credential verification to assure ease of operability between drivers.

The system may also be coupled with a state detector such as a breathalyzer, a noninvasive finger scan, a heart rate monitor, brain activity monitor, or other device for detecting conditions of a driver to restrict driving based on those conditions—for example, to detect the onset of a heart attack or a tired driver or to prevent road rage.

The system may optionally be connected to a computer or the information downloaded wirelessly to allow logs to be analyzed and settings to be customized. A computer software program may be operable to connect to the system, authenticate, and download the information. The information may be analyzed, published to a web page, or used to provide reports of third party driving habits, such as children or employees.

Another embodiment of the present invention envisions a system to restrict driving privileges of particular individuals by a government, police, or law enforcement agency. For example, an individual may only be allowed to drive to and from work although the vehicle may be used by other people without such restrictions. Therefore, such a system could use biometric verification to enforce particular driving restrictions with respect to particular drivers.

Another embodiment of the present invention envisions a master-override feature for use by authorized individuals such as police, tow-trucks, and emergency responders. When a vehicle's biometric override feature has been enabled it may flash lights, emit sounds, or communicate wirelessly with a database or alert system.

Another embodiment of the present invention envisions a biometrics authentication system coupled to an alternate driving device such as a joystick, eye-tracker, or voice-controlled steering or driving control system. Such a system could include a fingerprint scanner positioned on a joystick, or a retinal scanner that also functions to track eye movement to control aspects of the driving in addition to providing driver authentication. A voice-activated biometric identifier may also be used for voice-activation of vehicle features such as the radio.

Another embodiment of the present invention envisions a system and method adapted to allow the biometric verification or credential information to be wirelessly transmitted to a law enforcement officer during a chase or when a vehicle is pulled over. Such transmission may be encrypted by the system and unencrypted by a handheld system or a system located in the officer's vehicle. The officer may download any logs from the system wirelessly or view any logs, including the recent route, speed, or drivers of the vehicle by performing a biometric scan cross-checked to their credentials inside the vehicle. The information may also be relayed to a central location for further analysis.

Another embodiment of the present invention envisions a system and method adapted to keep a log of the previous drivers of the vehicle. The information may be stored in the system, transmitted wirelessly at particular intervals, transmitted each time the car is started or the foot is depressed on the brake, or transmitted at fixed intervals such as during vehicle renewal.

Another embodiment of the present invention envisions a system and method adapted to allow the biometric verification or credential information to be transmitted to a parking lot attendant or automated system to provide desired services, such as premium parking spots to particular customers.

Another embodiment of the present invention envisions an easy-to-use voice-responsive system. The system can provide audible prompts and includes voice recognition to accept commands. When a driver enters the vehicle the system can greet the driver, prompt the driver to provide their credentials and biometric information. A cross-check can be performed and a database queried. If the verification is successful, the driver may be further greeted, presets may be set on the radio or other in-vehicle devices, and the vehicle enabled. If the verification fails the driver may be given additional attempts before being prompted to leave the vehicle. If the driver does not leave the vehicle an alarm may sound or a designated person or police may be notified.

The driver may also request guidance about a route or assistance in finding a store. Advertisements may be presented based on the driver. Coupons may also be offered. An individual, for example, looking for a dry cleaner along a particular route or within a radius may be presented with a list of options including coupons. Advertisers may agree to pay in exchange for a premium listing including better placement or further details.

Embodiments of the present invention, however, are not limited to automobiles. For example, suitable embodiments of the present invention can be used in trucks, airplanes, railroad cars, boats, elevators, metro systems, high-speed vehicles, motorcycles, and other forms of transportation. This system may be encased in a waterproof film or box such as for use in outdoor applications such as motorcycles. The system may also be integrated into the dashboard of motorcycles. The system may also be used in rental vehicles to prevent unauthorized (or unauthenticated) drivers.

In any of the above suitable embodiments it may be desirable to provide biometric verification each time somebody sits in the driver's seat, periodically during driving, when requested by law enforcement, when a further form of identification fails, such as a password, keycard, or verifiable credential, or when authorization is required to enter a toll or restricted road or area.

In any of the above suitable embodiments the biometric information may be encrypted and transmitted, including wirelessly, to a local official, a transceiver/receiver unit, or to a satellite, cellular or other receiving station.

There may be different levels of credentials, such as an owner, a parent, a valet, a friend, a police officer, a tow-truck, or the dealership. The system may be programmed to respond differently to different credentials. Credentials may be assigned levels of authorization, and different levels of authorization may permit different actions. Police officers, for example, may have high levels of authorization, permitting them to override the system or view logs from other drivers. Valets, on the other hand, may have low authorization levels permitting them to drive at low speeds and restricting them from, for example, opening the trunk.

The system may be configured to interface directly with the vehicle computer, or may communicate through blue-tooth, other wireless protocols, or through the vehicle's ODBC diagnostic port or directly by interface with the ignition or starter.

As envisioned, certain embodiments of the present invention include cross-checking a biometric identification with a valid driver's license and valid insurance card to control access to a vehicle. In one embodiment, a driver would enter a vehicle, scan their driver's license and insurance card, and then perform a biometric identification. The system would cross-check the information on the driver's license, insurance card, and biometric identification. If the cross-check was successful, the car would be allowed to start. The information stored on the driver's license and insurance card in an exemplary embodiment would be stored on a tamper-resistant smart card. The biometric information could be cross-checked against the information stored in the smart card, or, in one representative embodiment, be used as a key to unlock an encrypted vehicle starting code stored in the smart-card.

As envisioned, in addition to cross-checking the biometric information with the driver's license and insurance card, substance detectors (e.g., breathalyzer, pupil dilation/retinal scanner device, IR detection device) would be used to verify that the driver is not under the influence of a prohibited substance.

A current owner of the vehicle can also add new drivers. For example, a spouse can add their significant other. This could be performed by the current owner verifying his biometric information and selecting an option (preferably through voice activated commands) to add a new driver. The current owner could also specify what rights the new driver would be entitled to. For example, the rights could be restricted to particular power of a vehicle, could restrict whether the new driver is allowed to add additional new drivers, and may select an expiration date for the new driver's privileges. The new driver would then sit in the driver's seat, perform a biometric authentication, and the information would be saved to the system's memory.

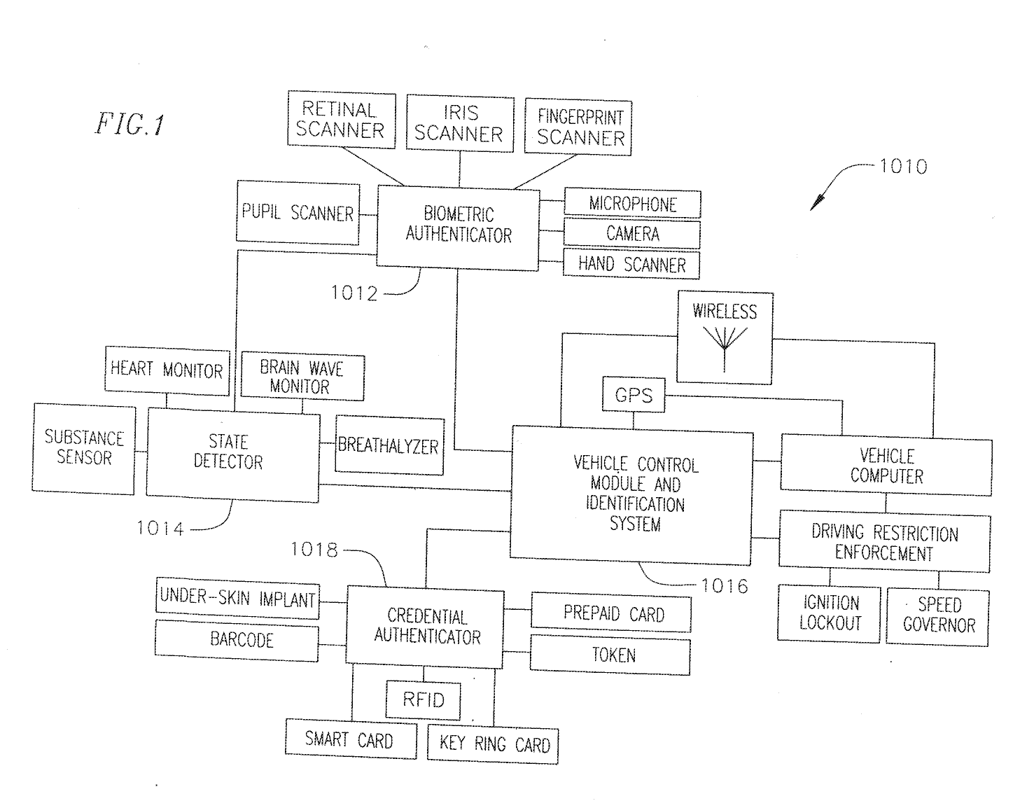

FIG. 1 shows a block diagram of a driver's card identification system and/or a system of preventing use (or unauthorized use) of a vehicle by an operator (or driver) of the vehicle according to an embodiment of the present invention.

As shown in FIG. 1, the system 1010 includes a control module (or system controller) 1016, a biometric authenticator 1012, a state detector 1014, and/or a credential authenticator (or sensor) 1018. The biometric authenticator 1012 is coupled to the control module 1016. The state detector 1014 can be a substance detecting sensor (or detecting device) adapted to provide a substance level in the operator to the control module 1016. Here, the control module 1016 is adapted to communicate a driving restriction to the vehicle if the substance level in the operator is above a tolerance level or if the operator is not authenticated by the authenticator 1012.

Also, in one embodiment of the present invention, the substance level is determined at an extremity of the operator, the operator is also authenticated at the extremity, and the extremity is selected from the group composed of finger, thumb, toe, ear, palm, sole, foot, hand, and/or head.

In one embodiment, the control module 1016 is further adapted to communicate with the vehicle to permit the vehicle to start if the operator has been authenticated by the authenticator 1012 and the substance level in the operator is not above the tolerance level. Also, as shown in FIG. 1, the authenticator 1012 may be a fingerprint authenticator, a face recognition authenticator, a hand-geometry authenticator, a voice authenticator, etc. In one embodiment, the authenticator 1012 includes a fingerprint sensor (or scanner), and the substance level in the operator is determined in-vivo at a tissue within the finger of the operator.

In one embodiment, the substance detecting sensor is adapted to detect an alcohol level in the operator. Here, the substance detecting sensor may include a broadband (or wideband) detector (e.g., a single photodiode detector) described in more detail below. In addition, as described in more detail below, the substance detecting sensor may include a broadband light source and a wavelength filtering system between the broadband detector and the light source. The wavelength filtering system and the broadband light are configured to direct a light beam at a specific wavelength band toward the broadband detector. In the context of the present application, the specific wavelength band can refer to one or more wavelengths or wavelengths ranging from one specific wavelength to another specific wavelength.

Referring back to FIG. 1, the credential authenticator (or sensor) 1018 adapted to sense a verifiable credential of the operator is coupled to the control module 1016. Here, the control module 1016 is adapted to verify that the operator authenticated by the authenticator 1012 matches the verifiable credential of the operator. As shown in FIG. 1, the verifiable credential that can be sensed by the credential authenticator includes a driver's license, an RFID tag, a smartcard, a credit card, a key ring including an infrared (IR) adapter, and/or an under-skin implant.

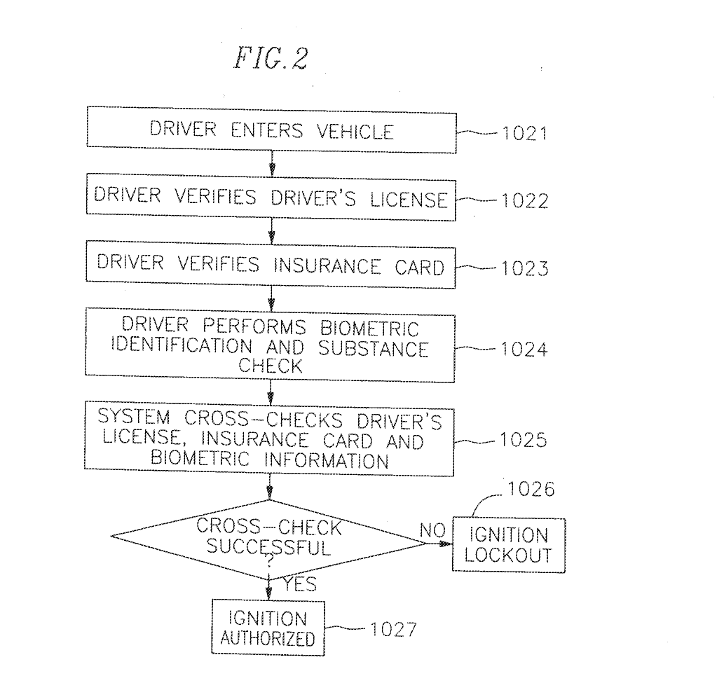

FIG. 2 shows a flowchart of process blocks associated with a driver's card identification system and/or a system of preventing use (or unauthorized use) of a vehicle by an operator (or driver) of the vehicle according to an embodiment of the present invention. As shown in FIG. 2, the operator or driver enters the vehicle with the system (e.g., the system 1010 of FIG. 1) in block 1021. In block 1022, the driver verifies his driver's license to the system. In block 1023, the driver verifies insurance card to the system. In block 1024, the driver performs biometric identification and substance check with the system. In block 1025, the system cross-checks the driver's license, insurance card, and biometric information. If the cross-check is unsuccessful, a control module of the system (e.g., the control module 16 of FIG. 1) communicates (or issues) a driving restriction, e.g., an ignition lockout, a power limit, etc., to the vehicle in block 1026. By contrast, if the cross-check is successful, the control module communicates with the vehicle to permit the vehicle to start or to authorize ignition (e.g., issues an ignition authorized command) in block 1027. Here, the controlled vehicle may include a vehicle selected from the group consisting of an aircraft, a mass transit vehicle, a watercraft, a piece of industrial equipment, and a piece of heavy machinery and equipment In one embodiment, the electronic data interface provides an output, such as a standard USB, Ethernet, or serial plug or specialized interfaces for dedicated applications such as in automobiles post-1996 using the OBDC-II interface.

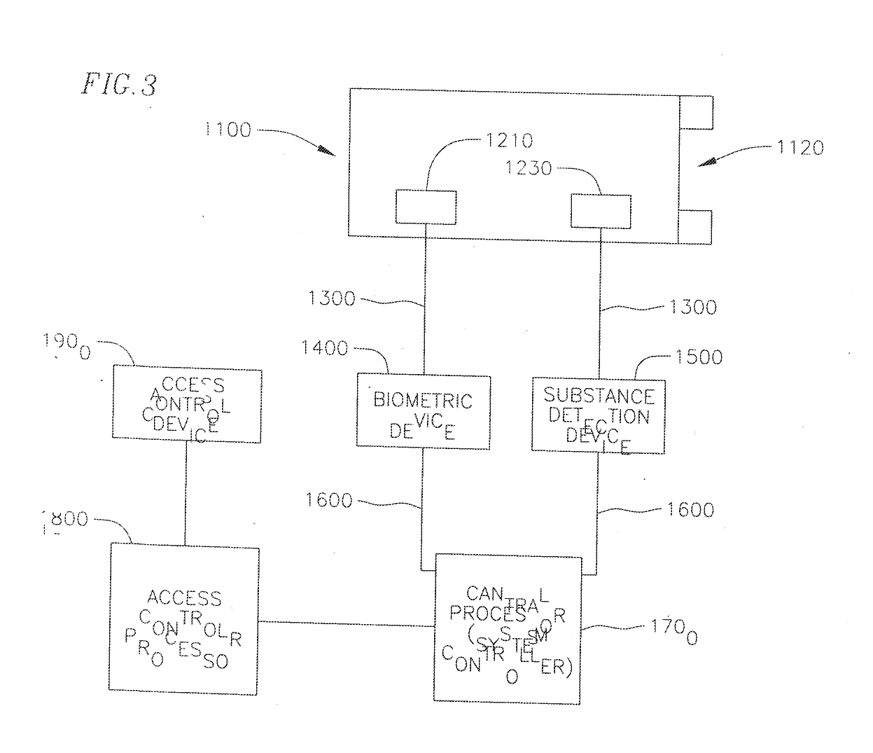

FIG. 3 shows a block diagram of an enhanced biometric and substance detection system and device according to an embodiment of the present invention. As shown, a sheath (or cradle) 1100 (e.g., a finger cradle) with a hole at one end 1120 for the insertion by an extremity of an operator (e.g., a finger) is provided. A biometric sensor 1210 and a substance sensor 1220 are included with the sheath 1100. In one embodiment, the extremity is selected from the group consisting of finger, thumb, toe, ear, palm, sole, foot, hand, and head.

In addition, the biometric sensor 1210 and the substance sensor 1220 are respectively coupled to a biometric device (or authenticator) 1400 and a substance detection device 1500 via leads 1300. The biometric device 1400 and the substance detection device 1500 are coupled to a central processor (or system controller or control module) 1700 via leads 1600. The central processor 1700 may then be coupled to the access control processor 1800, which may be coupled to an access control device or interface 1900.

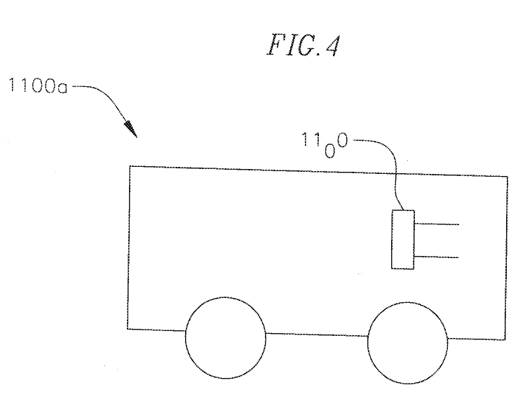

Referring to FIG. 4, in one embodiment, the enhanced biometric and substance detection system and device of FIG. 3 is incorporated within a vehicle 100a. In one embodiment, the vehicle 1100a is selected from the group consisting of an aircraft, a mass transit vehicle, a watercraft, a piece of industrial equipment, and a piece of heavy machinery and equipment. In more detail, the vehicle 1100a includes the sheath (or cradle) 1100 for insertion by the extremity of the operator.

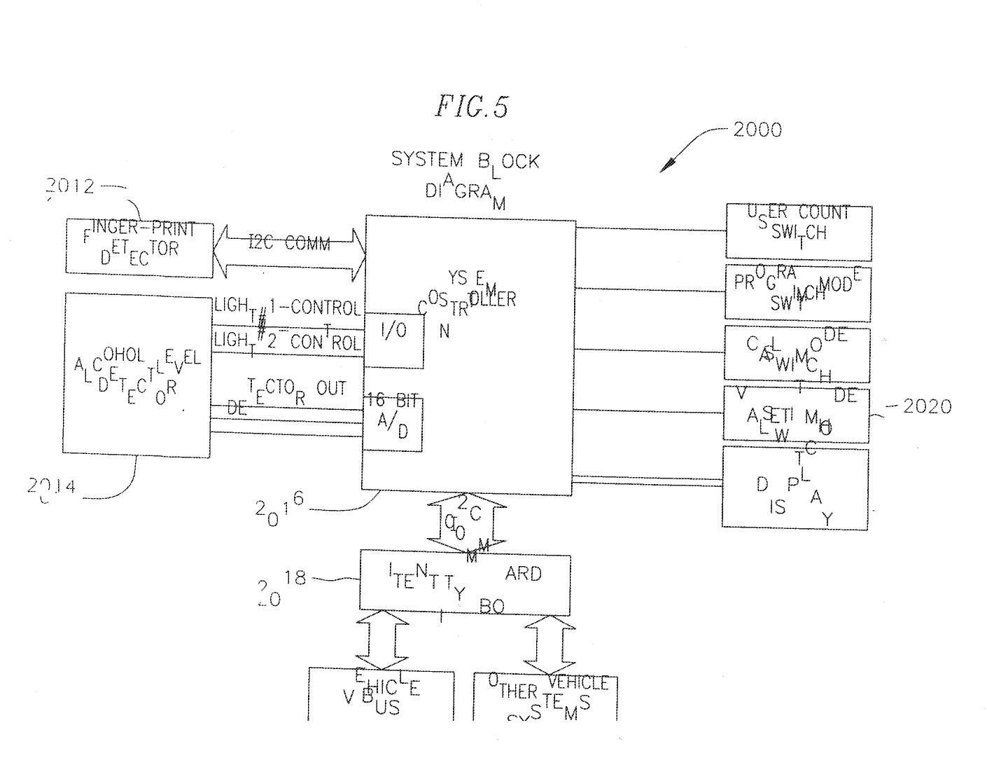

FIG. 5 is a block diagram of a system 2000 for inhibiting a power of a vehicle given to a third party, for in-vivo measurement of a concentration of a substance in a tissue of a person, and/or for preventing use of a vehicle by an operator of the vehicle according to certain embodiments of the present invention. As shown in FIG. 5, the system 2000 includes a control module (or system controller) 2016, a biometric authenticator (or fingerprint detector) 2012, a substance detecting sensor (or detecting device or alcohol level detector) 2014, and/or an identity board 2018. The biometric authenticator 2012 is coupled to the control module 2016 via a bus (e.g., via I2C Comm), and the identity board 2018 is also coupled to the control module 2016 via a bus (e.g., I2C Comm). The substance detecting sensor 2014 can be a substance detecting sensor adapted to provide a substance level in a user (e.g., the third party, the person, the operator, etc.) to the control module 2016 via a bus having a first light source control communication line (Light#1-Control), a second light source control communication line (Light#2-Control), a detector communication line (Detector Out). Here, the control module 2016 is adapted to communicate a driving restriction to the vehicle if the substance level in the operator is above a tolerance level or if the operator is not authenticated by the authenticator 2012.

Also, in one embodiment of the present invention, the substance level is determined at an extremity of the operator, the operator is also authenticated at the extremity, and the extremity is selected from the group composed of finger, thumb, toe, ear, palm, sole, foot, hand, and/or head.

In one embodiment, the control module 2016 is further adapted to communicate with the vehicle to permit the vehicle to start if the operator has been authenticated by the authenticator 2012 and the substance level in the operator is not above the tolerance level.

In one embodiment, the substance detecting sensor 2014 is adapted to detect an alcohol level in the operator. Here, the substance detecting sensor 2014 may include a broadband detector (e.g., a single photodiode detector) as described above. In addition, the substance detecting sensor may include a first diode laser configured to direct a light beam at a first specific wavelength toward the broadband detector and a second diode laser configured to direct a light beam at a second specific wavelength toward the broadband detector. Here, the broadband detector may be coupled to a 16 bit analog/digital (A/D) interface of the control module 2016 via the detector communication line (Detector Out). The first light source may be coupled to an input/output (I/O) interface of the control module 2016 via the first light source control communication line (Light#1-Control), and the second light source may be coupled to the I/O interface of the control module 2016 via the second light source control communication line (Light#2-Control).

In addition, FIG. 5 shows that the system controller 1010 is coupled to a user count switch, a program mode switch, a calibration mode switch, a valet mode switch 2020, and a display, and the identity board is coupled to a vehicle bus and other vehicle system. Here, the valet mode switch 2020 is for activation and deactivation of the valet mode (e.g., to inhibit the power of the vehicle).

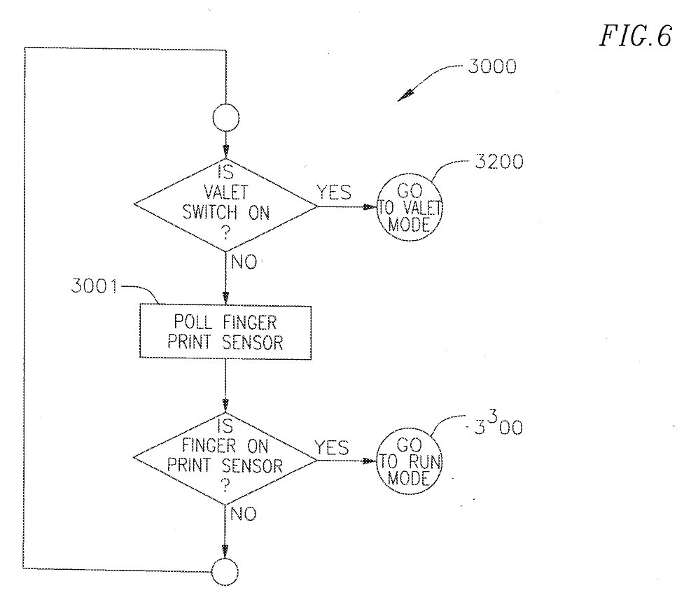

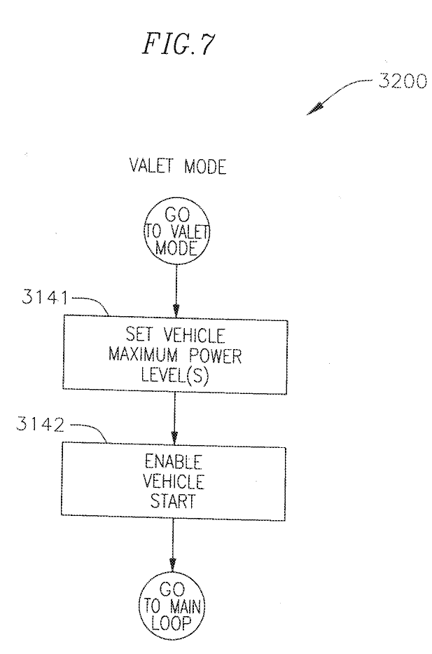

FIGS. 6, 7, and 8 show flowcharts of process blocks of system logics for inhibiting the power of the vehicle given to the third party, for in-vivo measurement of the concentration of the substance in the tissue of the person, and/or for preventing use of the vehicle by the operator of the vehicle according to certain embodiments of the present invention. As shown in FIG. 6, the system logics has a main loop 3000 that can be operating either in a run mode 3300 or a valet mode 3200. As shown in the main loop 3000 of FIG. 35, the system logics determine if the valet switch 2020 is activated (e.g., turned on). As shown in FIGS. 6 and 7, if the valet switch 2020 is turned on, the system logics go into the valet mode 3200 by, e.g., setting the vehicle's maximum power level(s) in block 3141, enabling the vehicle to start in block 3142, and returning to the main loop 3000.

As envisioned in one embodiment of the present invention, a system controller (e.g., the system controller 1010) is adapted to communicate a power restriction to a power inhibiting device adapted to selectively inhibit the power of the vehicle. In one embodiment, the system controller communicates the power restriction to the power inhibiting device to inhibit power of the vehicle upon an activation of a mode-indicating device (e.g., the valet mode switch 2020) by an authenticated driver and until a deactivation of the mode-indicating device by the authenticated driver. In one embodiment, the system controller is further adapted to restrict the activation and the deactivation of the mode-indicating device unless the authenticated driver has been authenticated by an authenticator (e.g., the authenticator 2012).

As envisioned, a power inhibiting device (or vehicle power inhibiter) according to an embodiment of the present invention may limit a vehicle's power by controlling air or fuel entering into the vehicle's engine. Controlling the fuel may be necessary with diesel powered vehicles. In addition, the vehicle power inhibiter of the present invention may limit a vehicle's power by suppressing ignition or by controlling a vehicle's ignition system. That is, there are various ways to limit a vehicle's power, such as suppressing ignition, controlling the fuel injection, etc. However, instead of suppressing ignition or controlling the fuel injection, certain embodiments of the present invention described in more detail below limit a vehicle's power by simply reducing a demand to increase power either electrically and/or mechanically.

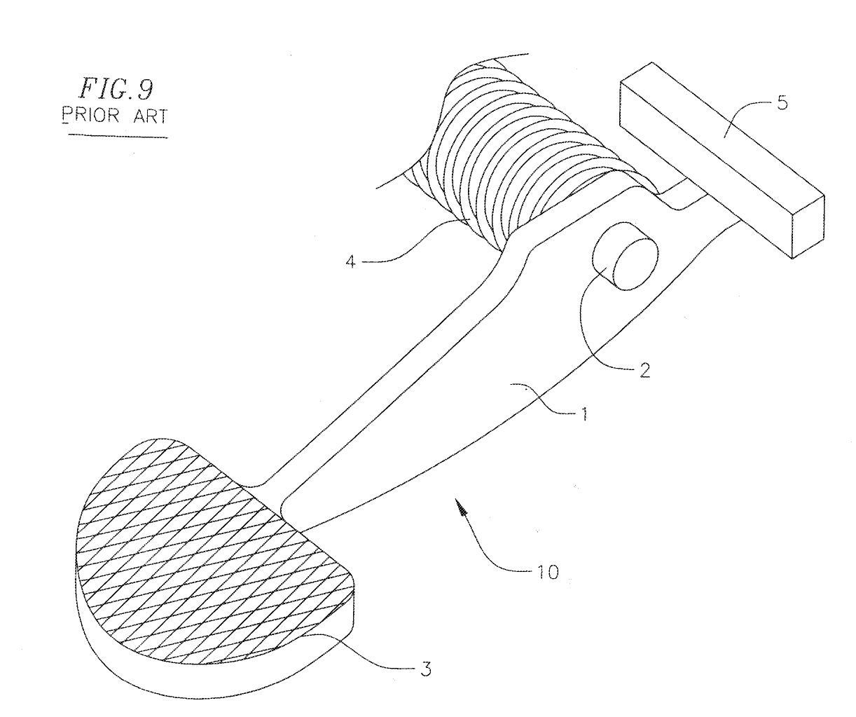

FIG. 9 is a depiction of an accelerator pedal 10. The accelerator pedal 10 includes an arm 1 rotatably mounted about a shaft or fixed pivot 2. The arm 1 includes a foot pedal pad 3 having a wide and flat surface area for allowing an operator's foot to make sufficient contact in order to control air or fuel flow to an engine, and therefore consequently control the engine's rotational speed or revolutions per minute (“RPM”).

The accelerator pedal 10 is usually made from steel plate, but may also be molded of high performance plastic. The accelerator pedal 10 additionally includes a bias spring 4 for returning the accelerator pedal to an idle position. The accelerator can be connected directly to the throttle body or to a carburetor by a cable. Alternatively, a drive-by-wire system may be used in which the accelerator pedal 10 is fitted with a sensor that measures rotational angle and sends data (or electrical data or signal) corresponding to the measured rotational angle to a controller (or processor) for controlling the throttle body or carburetor. The accelerator pedal 10 further includes an upper limit stop 5 for setting idle position. The upper limit stop 5 is obstructed (or blocked) by a member below the stop 5 when the accelerator pedal 10 is returned to the idle position by the bias spring 4 (or when the accelerator pedal 10 is in the idle position).

Typically, wide open throttle is achieved when the accelerator pedal 10 is pressed sufficiently close to the floor. Once wide open throttle is achieved, pressing the accelerator pedal 10 further such that the accelerator pedal 10 is fully against the floor serves no additional function. Thus, for a vehicle power inhibiter installed under an accelerator pedal 10 to inhibit engine RPM, the vehicle power inhibiter should have an obstructing member with a height such that the accelerator pedal 10 is blocked or prevented from allowing the throttle to be fully opened.

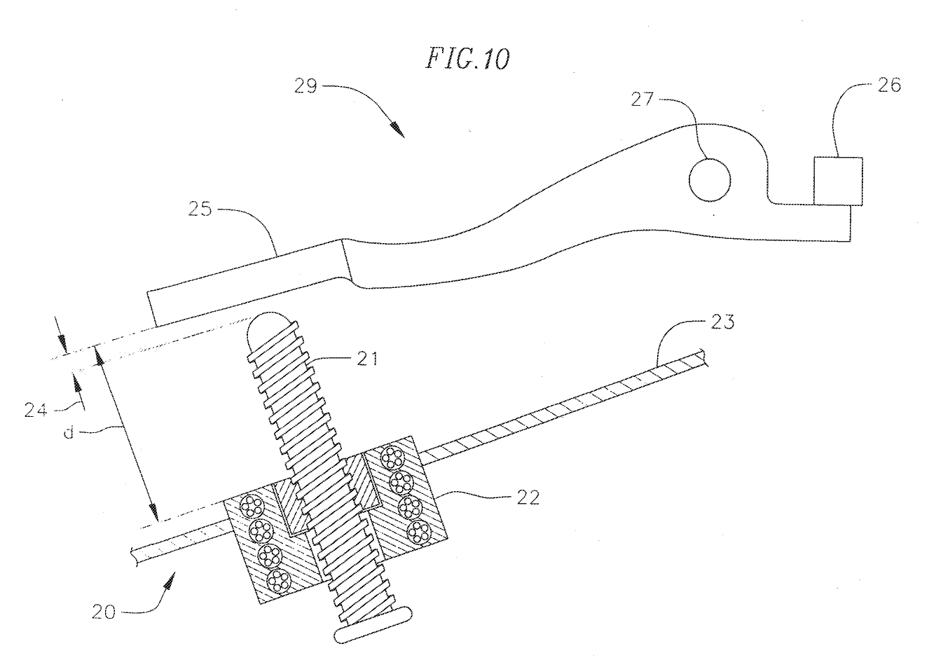

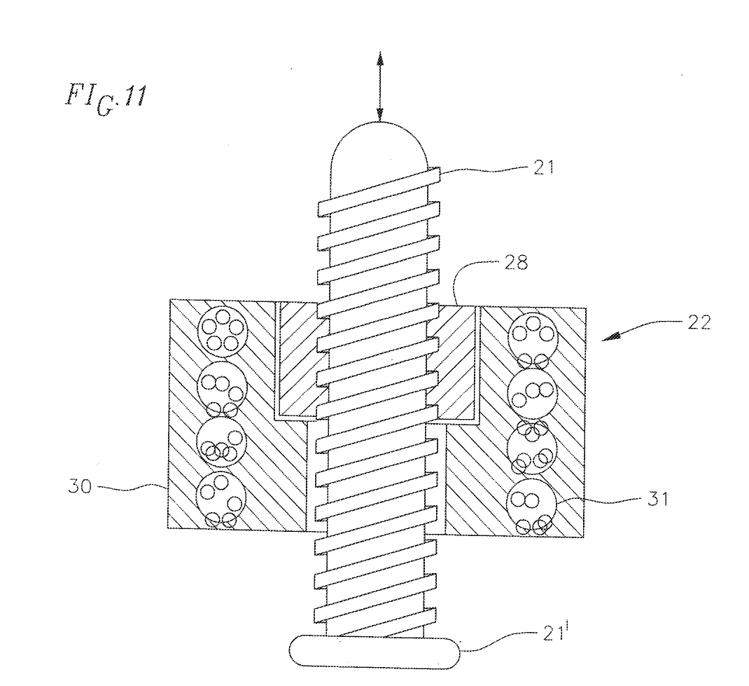

FIG. 10 is a view of an accelerator pedal vehicle power inhibiter 20 implemented by a motor-actuated screw mechanism according to an exemplary embodiment of the present invention. The accelerator pedal inhibiter 20 includes a threaded restricting pin 21 that rotates within a threaded collet 28 (see FIG. 11) of a hollow shaft electric motor assembly 22. The electric motor assembly 22 is fitted to an underside of the floor pan 23. The electric motor assembly 22 rotates the threaded collet 28. As the threaded collet 28 turns, the threaded restricting pin 21 is either rotated or counter-rotated into various obstructing positions. The level at which power is inhibited by the threaded restricting pin 21 is related to an adjustable gap 24 between the tip of the threaded restricting pin 21 and the base of an accelerator pedal foot pad 25 when the accelerator pedal foot pad 25 is in idle position. As discussed above, idle position is defined by a stop 26 located at a distal end from the accelerator pedal foot pad 25.

Assuming that the accelerator pedal foot pad 25 has a full range of a distance d to the floor pan 23 as the accelerator pedal 29 pivots on shaft 27, when the threaded restricting pin 21 has a height of d (i.e., the threaded restricting pin is in a fully obstructing position), the adjustable gap 24 will be equal to zero, and the accelerator pedal 29 will be prevented from moving from an idle position. When the threaded restricting pin 21 has a height of zero (i.e., the threaded restricting pin is in a clearing position), the adjustable gap 24 will be equal to d, and the accelerator pedal 29 will have a full range of motion to allow the throttle to be fully opened.

As discussed above, full throttle is achieved when the accelerator pedal foot pad 25 is some distance from the floor pan 23. Assuming that such height is equal to h, full throttle can be achieved even if the threaded restricting pin 21 is set to a height of h. Thus, for the threaded restricting pin 21 to inhibit power of a vehicle, the threaded restricting pin 21 must be set with a height greater than d−h and less than or equal to d. Thus, the adjustable gap 24 will be greater than or equal to zero and less than d−h when power of a vehicle is inhibited.

FIG. 11 is an internal view of the vehicle power inhibiter depicted in FIG. 10 according to an embodiment of the present invention. The threaded restricting pin 21 may have a multi-start thread for providing rapid motion at relatively slow motor speed for fast engagement. In addition, the threaded restricting pin 21 may have a square thread for providing a requisite amount of friction necessary to prevent the threaded restricting pin 21 from being driven in the opposite direction by excessive force on the accelerator pedal. The threaded restricting pin 21 is positioned by controlling the number of motor turns. To control the number of motor turns, a turns-counting sensor or a stepper motor may be used. In order to avoid over rotating the threaded restricting pin 21, the threaded restricting pin 21 includes a stop 21′ for engaging an edge of the electric motor assembly 22 when the threaded restricting pin 21 is fully engaged.

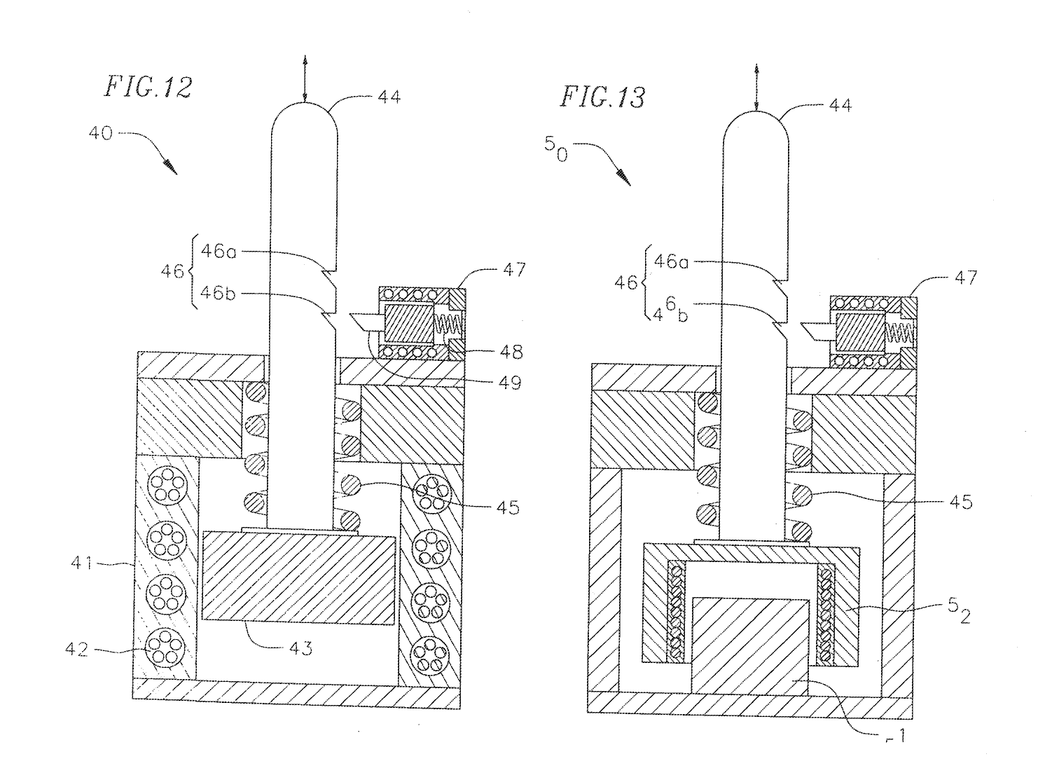

As shown in FIG. 11, the electric motor assembly 22 includes a motor stator 30 with windings 31 for allowing for the motor to operate in a clockwise or counter-clockwise direction. The electric motor assembly 22 further includes a threaded collet 28 that fits into the hollow shaft of the electric motor assembly 22. The threaded collet 28 may be a solenoid actuated split collet for allowing for a rapid disconnect of the threaded restricting pin 21 from the threaded collet 28. In such an embodiment, a bias spring (e.g., bias spring 45 of FIG. 12) may be used with the threaded collet 28 for a rapid retraction of the threaded collet 28 from engaging the threaded restricting pin 21.). As such, the embodiment as shown in FIG. 11 provided a return to normal (or fail safe) mechanism to allow the vehicle to operate normally (or unrestricted by a power demand) in the event that the power inhibiter 20 would to fail (or would to be without power).

FIG. 12 is a view of a solenoid vehicle power inhibiter 40 according to an exemplary embodiment of the present invention. The vehicle power inhibiter 40 includes a solenoid 41 with an electromagnetically inductive coil 42 wound around a circumference of the solenoid 41 to move an armature. The armature is a magnet 43 that moves upward depending on the electromagnetic force applied by the solenoid 41. The magnet 43 fits into the hollow shaft of the solenoid 41. A restricting pin 44 is attached to a top of the magnet 43. A bias spring 45 is positioned around the base of the restricting pin 44 for biasing the restricting pin 44 into a non-engagement position. The restricting pin 44 includes detents 46 for allowing the restricting pin 44 to be locked into various positions by the latch 47. The various positions may include a plurality of positions such as an idle detent 46b for blocking or preventing an accelerator pedal of the vehicle from going above an idle position (e.g., to kept the RPM of the vehicle at idle) and a valet detent 46a for blocking or preventing the accelerator pedal of the vehicle from going above a power demand that is necessary to park the vehicle.

To engage the vehicle power inhibiter 40, power is applied to the solenoid 41 to apply an electromagnetic force against the magnet 43. The magnet 43 is moved up until the latch 47 locks the restricting pin 44 in place into the first detent. The latch 47 is electronically controlled to lock in one of the various locking positions. Thus, if an idle position is desired, the latch 47 will retract, the solenoid 41 will be powered to apply an electromagnetic force against the magnet 43 to move the magnet 43 and the restricting pin 44 until the latch 47 locks into the next detent, which in this embodiment is the idle detent 46b.

When an operator desires to disengage the restricting pin 44, the latch 47 is retracted. Because no power is applied to the solenoid 41 when the restricting pin 44 is disengaged, the bias spring 45 shifts the restricting pin 44 into a non-engagement position.

As shown in FIG. 12, the pin 49 of the latch 47 has a shape that allows the armature to be propelled up by the solenoid 41, but disallows the armature to move downward once the pin 49 of the latch 47 is in a particular detent 46. In one embodiment, when no power is applied to the latch 47, the pin 49 is disengaged from the particular detent 46 because a latch bias spring 48 shifts the pin 49 into a non-engagement position to thereby allow the restricting pin 44 to be also in the non-engagement position (e.g., to be disengaged from the accelerator pedal of the vehicle). As such, the embodiment as shown in FIG. 12 provided a return to normal (or fail safe) mechanism to allow the vehicle to operate normally (or unrestricted by a power demand) in the event that the power inhibiter 40 would to fail (or would to be without power).

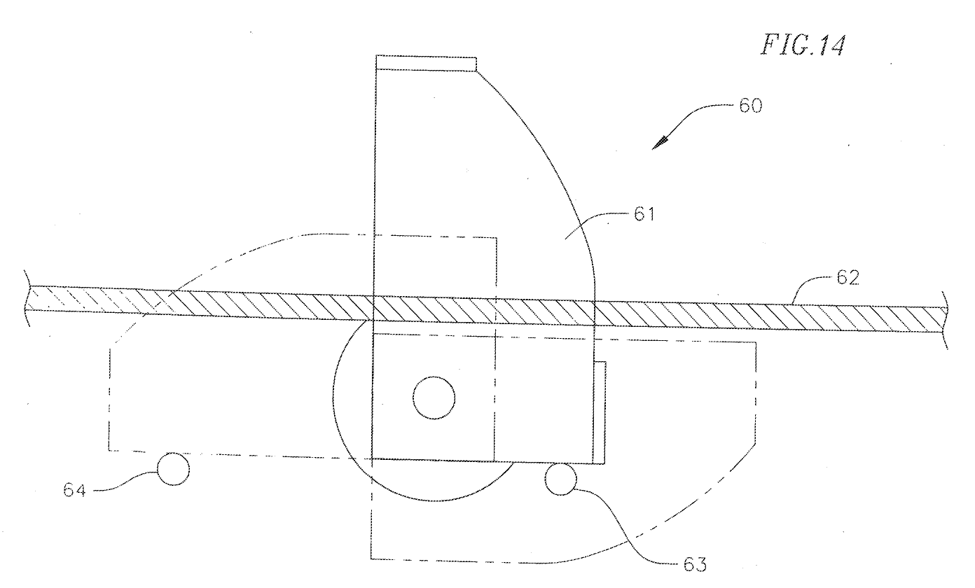

FIG. 13 is a view of a moving coil vehicle power inhibiter 50 according to an exemplary embodiment of the present invention. The vehicle power inhibiter of FIG. 13 operates under similar principles as the vehicle power inhibiter 40 of FIG. 12, except the vehicle power inhibiter 50 includes a stator magnet 51 and the coils 52 are movable. Power must be provided to the moving coils 52. The vehicle power inhibiter 50 is more powerful and controllable than the vehicle power inhibiter 40, but it is more expensive to build and requires a higher current to operate.

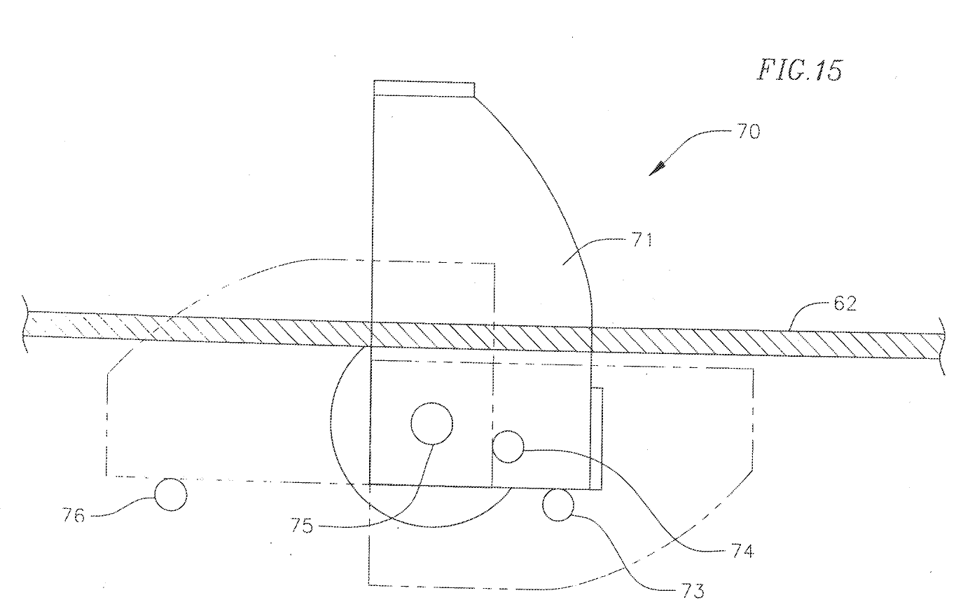

FIG. 14 is a view of a rotating cam vehicle power inhibiter 60 according to an exemplary embodiment of the present invention. The vehicle power inhibiter 60 is an actuator system with a rotating cam plate 61 driven by a rotary drive motor 3. The cam plate 61 is fitted directly below the pedal and is operated through a slot in the floor pan 62. The vehicle power inhibiter 60 includes retractable stop pins 63, 64 for locking the cam plate 61 in idle position and valet position, respectively.

As shown in FIG. 14, in position A the cam plate 61 is in a fully counter-clockwise position, resting hard against the fixed stop pin 64, and the accelerator pedal will only be allowed to travel to the valet mode stop position. In position B, the cam plate 61 is located 90 degrees clockwise from position A to rest hard against the fixed stop pin 63. Due to the shape of the cam plate 61, in position B the accelerator pedal will be allowed to travel to the idle stop position. In position C, the fixed stop pin 63 is retracted and the cam will rotate a further 90 degrees clockwise to its stowed position.

Such an embodiment is simple and requires only a low powered motor, two position switches and a small solenoid. Under idle and valet modes, neither the motor nor the solenoid will be powered.

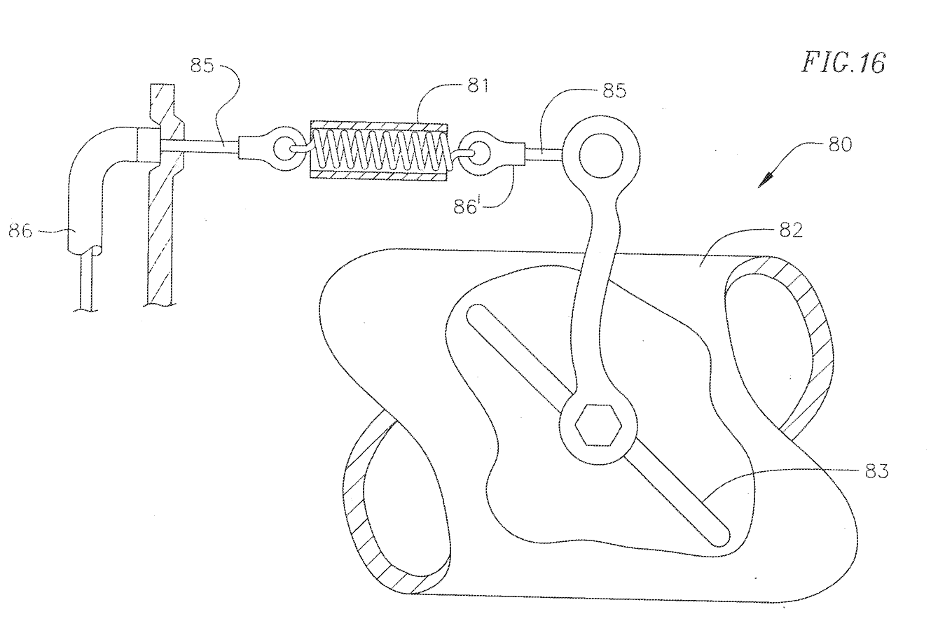

FIG. 15 is a view of a rotating cam vehicle power inhibiter 70 according to another exemplary embodiment of the present invention. The vehicle power inhibiter 70 operates similarly to the vehicle power inhibiter 60, except the vehicle power inhibiter 70 includes a torsion spring 75 for applying torque to the cam plate 71 in the clockwise direction. Here, a valet fixed stop pin 74 is positioned to prevent movement in the clockwise direction. Furthermore, a stop pin 76 is provided to prevent the cam plate from rotating counter-clockwise when it is in position A. Moreover, to more into position B, the valet fixed stop pin 74 is released (or retracted) from its engaged position with the cam plate 71 and the came plate 71 is rotated 90 degrees clockwise (e.g., due to the force of the torsion spring 75) from position A to rest hard against a fixed stop pin 73.

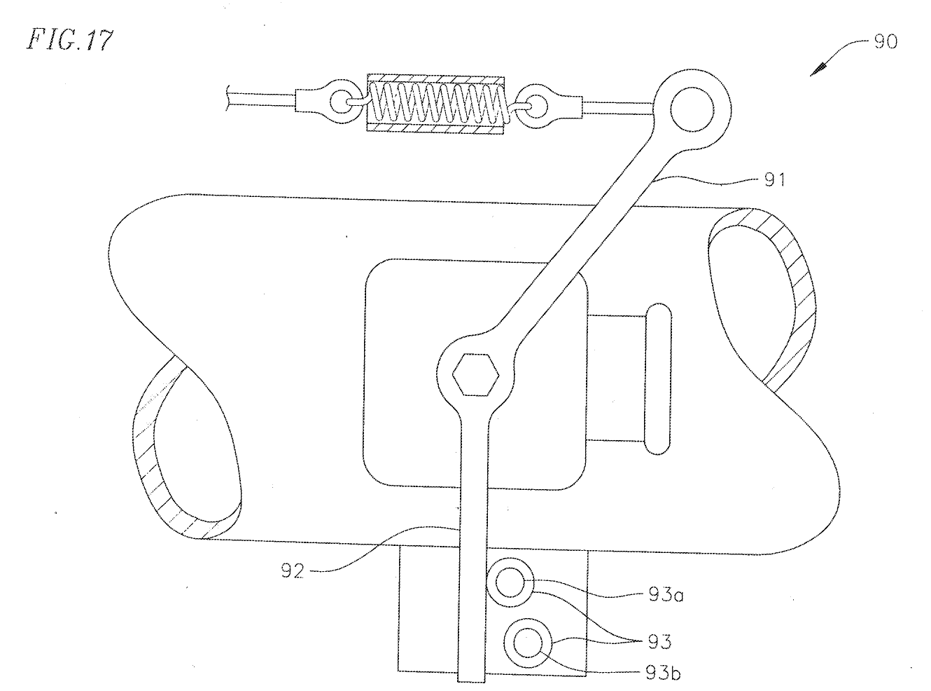

FIG. 16 is a view of a cable driven throttle 80 with an overload protection spring 81 according to an exemplary embodiment of the present invention. A cable driven throttle includes a throttle body 82 with an internal butterfly valve 83 that controls air flow into the carburetor. The butterfly valve 83 is controlled by a swivel joint 84. An operating cable 85 connects to a distal end of the swivel joint 84. The operating cable 85 includes a cable sheath 86. When the accelerator pedal is moved, the cable 85 is either pulled or released, which opens or closes the butterfly valve 83 within the throttle body 82. According to an exemplary embodiment, the cable 85 may include an overload protection spring 81 and a spring coupler 86′ for preventing the cable 85 from being jerked or pulled too quickly when the accelerator pedal is rapidly pressed.

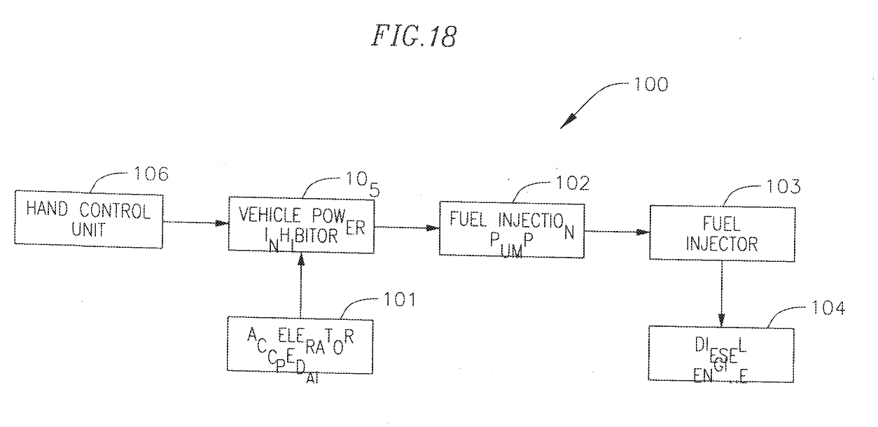

FIG. 17 is a view of a vehicle power inhibiter 90 for cable driven throttles according to an exemplary embodiment of the present invention. In such an embodiment, a vehicle's power may be controlled by controlling air flowing into the carburetor. According to an exemplary embodiment, the cable driven throttle 90 may further include a member for limiting air flow into the carburetor. Such member includes a throttle arm 91 with an extension/lever 92 for engaging one of a set of retractable pins 93. The retractable pins 93 may include an idle-only retractable pin 93a and a valet-mode retractable pin 93b. The retractable pins 93 are actuated by a latching solenoid working against a tension spring. The solenoid mechanically latches the pin in the extended position until the solenoid is energized to release the latch and allows the spring to pull the pin to disengage from the extension/lever 92.

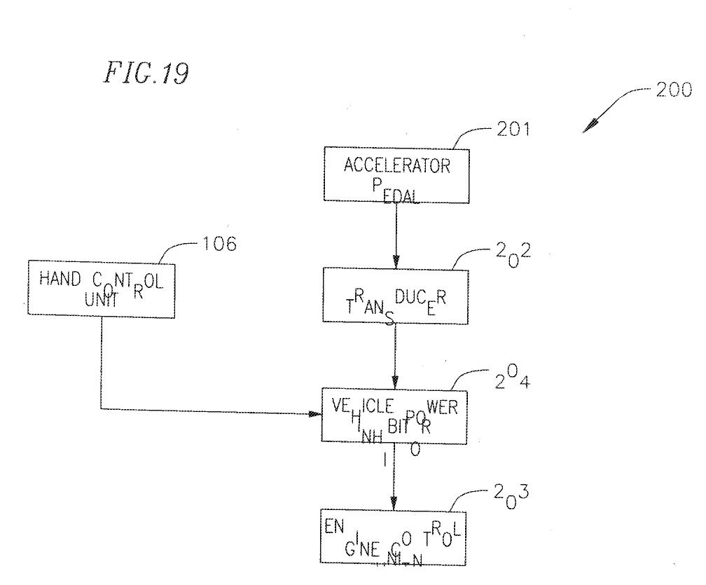

FIG. 18 is a block diagram of a vehicle power inhibiter system 100 for diesel powered vehicles according to an exemplary embodiment of the present invention. In the vehicle power inhibiter system 100, the vehicle power inhibiter 105 is linked between the accelerator pedal 101 and the fuel injection pump 102. The vehicle power inhibiter 105 may be controlled through hand control unit 106 located conveniently for an occupant of a vehicle. The hand control unit 106 allows an occupant of a vehicle to set the vehicle power inhibiter 105 for various settings, including an idle mode for preventing an RPM above idle and a valet mode for preventing an RPM above that which is necessary to park the vehicle. The hand control unit 106 may additionally include a receiver for allowing a transmitter to send a particular setting. For example, a vehicle owner with a transmitter device may set the mode after he or she departs from the vehicle, perhaps while walking into a restaurant.

The vehicle power inhibiter 105 may mechanically control the fuel injection pump 102, which controls an amount of fuel provided to the fuel injection system 103, and hence an amount of fuel provided to the diesel engine 104. That is, the vehicle power inhibiter 105 is used to limit a fuel supply to thereby limit a demand to increase the power of the vehicle.

With the mechanically controlled fuel injection pumps 102, the vehicle power inhibiter 105 may include a control arm coupled to a linear lever of the fuel injection pump 102 and one or more retractable pins that selectively limit a travel of the linear lever to limit a demand to increase power of a vehicle, and may have a structure and/or a function that is substantially the same as the vehicle power inhibiter 90 of FIG. 17 for limiting an air supply to limit a demand to increase the power of the vehicle.

In more detail, the power inhibiter (or inhibiting device) 105 may include a control, a first retractable pin, and a second retractable pin. Here, the control arm is coupled to a linear lever of a fuel injection pump and adapted to selectively limit a travel of the linear lever to limit a demand to increase the power of the vehicle. The first retractable pin adapted to selectively move between a stopping position and a release position, the stopping position of the first retractable pin being adapted to limit a travel of the control arm to a first arm position to limit the travel of the linear lever to a first lever position to limit the demand to increase the power of the vehicle to a first power level. In addition, the second retractable pin is adapted to selectively move between a stopping position and a release position, the stopping position of the second retractable pin being adapted to limit the travel of the control arm to a second arm position to limit the travel of the linear lever to a second lever position to limit the demand to increase the power of the vehicle to a second power level.

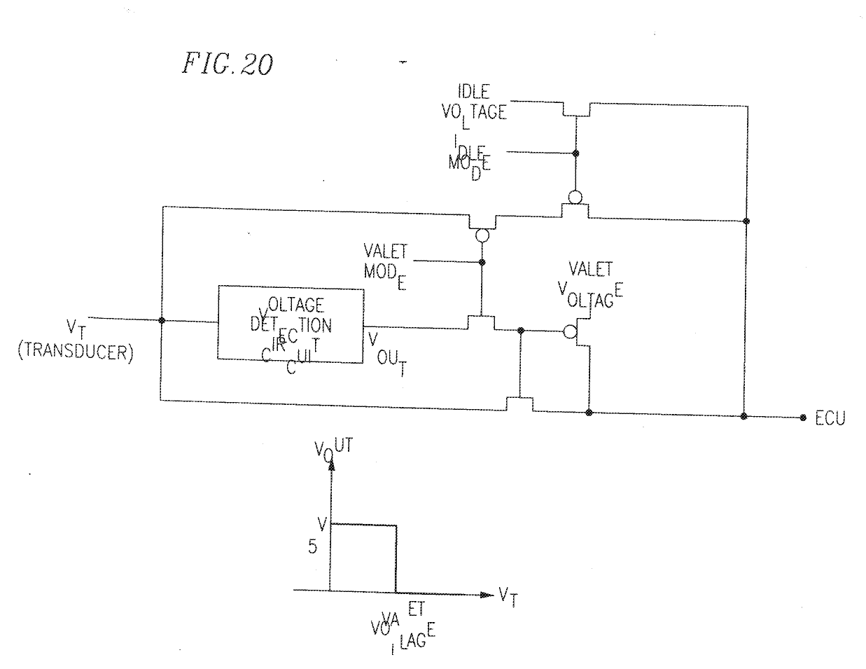

FIG. 19 is a block diagram of a vehicle power inhibiter system 200 for a drive-by-wire system according to an exemplary embodiment of the present invention. Drive-by-wire technology replaces traditional mechanical systems with electronic control systems. A drive-by-wire type system is disclosed in U.S. Pat. No. 5,549,089, which is herein incorporated by reference. In the vehicle power inhibiter system 200, the vehicle power inhibiter 204 receives an idle or valet setting signal from the hand control unit 106 and an accelerator control input signal from the transducer 202. The accelerator control input signal corresponds to the position of the accelerator pedal 201. The vehicle power inhibiter 204 may be a voltage control circuit adapted to switch between voltage control circuits with idle and valet settings. Such a voltage control circuit may include a first section (or part) to block a demand to increase the power of a vehicle and a second section (or part) to unblock the demand to increase the power. When the voltage control circuit blocks a demand to increase the power of a vehicle, the voltage control circuit intercepts the accelerator control input signal from the transducer 202, modifies the accelerator control input signal, and provides the modified accelerator control input signal to the engine control unit (ECU) 203. The accelerator control input signal may be modified with one or more voltage limiters. The one or more voltage limiters may be adapted to limit a voltage to one or more settings, such as an idle setting and a valet setting, which ultimately limits the power of the vehicle to one or more power levels. In one embodiment, at least one of the voltage limiters is a resistance voltage limiter. In another embodiment, each of the voltage limiter is a resistance voltage limiter.

For example, in one embodiment, if the vehicle power inhibiter 204 is set to an idle setting, the vehicle power inhibiter 204 will provide an idle accelerator control input signal to the engine control unit 203. Further, in one embodiment, if the vehicle power inhibiter 204 is set to an valet setting, the vehicle power inhibiter 204 will provide an unmodified intercepted accelerator control input signal to the engine control unit (ECU) 203 while the intercepted signal corresponds to a position of the accelerator pedal 201 between an idle setting and a valet setting, and will provide a valet accelerator control signal while the intercepted signal corresponds to a position of the accelerator pedal 201 past the valet setting.

Moreover, although the vehicle power inhibiter 204 is shown to be a separate unit integrated between the transducer (transducer/accelerator pedal position sensor) 202 and the ECU 203, the present invention is not thereby limited. For example, in another embodiment, the power inhibiter 204 may alternatively be combined with the ECU 202 and/or the transducer/accelerator pedal position sensor 202.

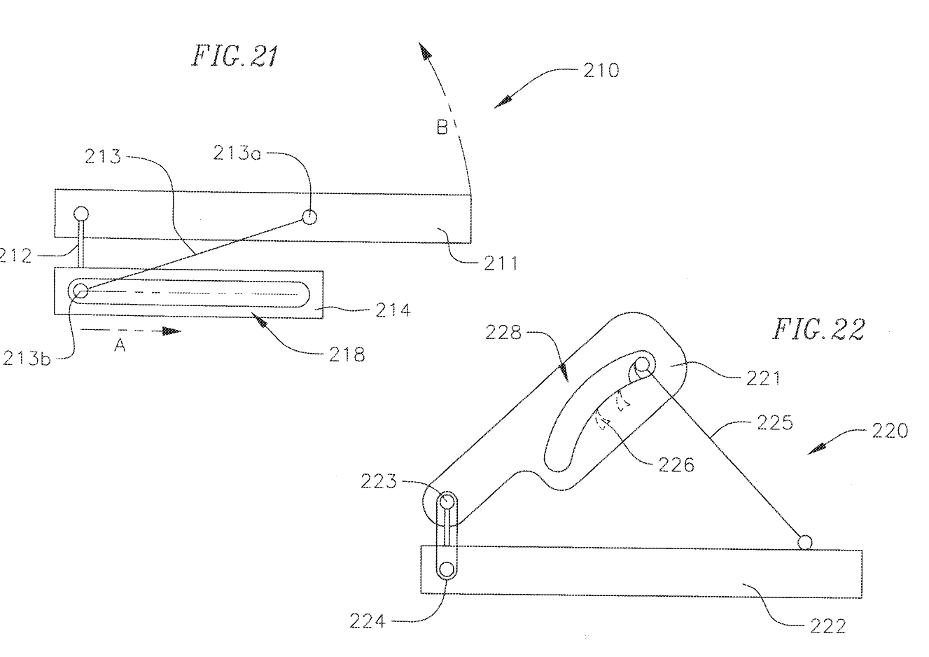

FIG. 20 is a circuit diagram of a vehicle power inhibiter system for the drive-by-wire system of FIG. 19. Output from the transducer V_{T} is supplied to a voltage detection circuit 209. The voltage detection circuit outputs 5V when V_{T} is less than the valet voltage and 0V when V_{T} is greater than or equal to the valet voltage. The hand control unit 106 allows a user to turn on and off valet and idle modes. As a consequence, V_{T} is provided to the ECU when idle and valet modes are off, the idle voltage is provided to the ECU when idle mode is on, V_{T} is provided to the ECU if the valet voltage is on and V_{T} is less than the valet voltage, and the valet voltage is provided to the ECU if the valet voltage is on and V_{T} is greater than or equal to the valet voltage.

The voltage detection circuit 209 may be a separate unit integrated between the transducer/accelerator pedal position sensor and the ECU, or alternatively, may be combined with the ECU and/or the transducer/accelerator pedal position sensor.

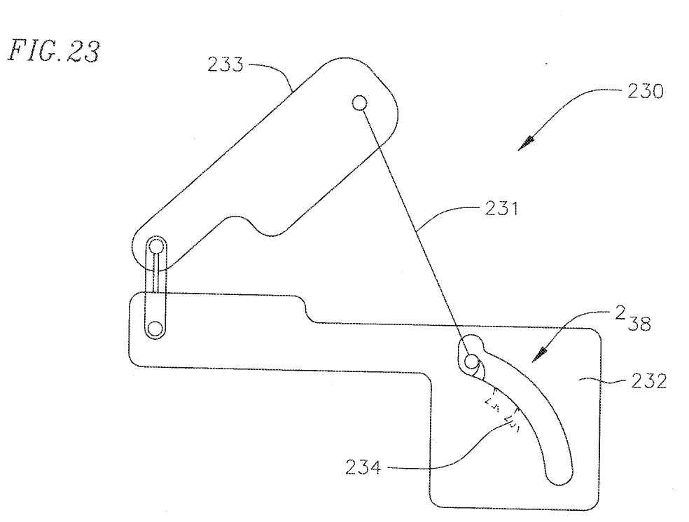

FIG. 21, FIG. 22, and FIG. 23 are views of vehicle power inhibiter systems 210, 220, 230 according to further exemplary embodiments of the present invention.

In FIG. 21, the vehicle power inhibiter system 210 includes an obstruction member 211 connected to a hinge 212 and a raising/lowering rod 213. The raising/lowering rod 213 is connected to a rotating pin 213a of the obstructing member 211. The hinge 212 is connected to a base member 214. The base member 214 includes a motor for rotating a pin of a gear 213b on a distal end of the raising/lowering rod 213. As the pin of the gear 213b is rotated, the gear 213b also moves along a length pathway (or track) 218 of the base member 214. As the gear 213b moves along the length pathway 218 of the base member 214 in direction A, the distal end of the raising/lowering rod 213 also moves along the length pathway 218 of the base member 214 in direction A, which causes the obstructing member 211 to rotate in the direction B. Here, the length pathway 218 is shown to be straight, but the present invention is not thereby limited.

In FIG. 22, the vehicle power inhibiter system 220 also has an obstructing member 221 and a base member 222. However, the obstructing member 221 is raised/lowered by rotating with respect to an axis 223. The axis 223 may be rotated by a belt 224 also connected to motor 224. As the obstructing member 221 is raised, a support rod 225 may move along an arcuate pathway (or track) 228 in the obstructing member 221. The support rod 225 locks the obstructing member in place. The obstructing member 221 may further include teeth 226 for locking a distal end of the support rod 225 in place. The teeth 226 may individually be activated/extended in power on mode when the obstructing member 221 is raised, and deactivated/retracted upon loss of power or when the obstructing member 221 is lowered. When the teeth 226 are deactivated/retracted, the obstructing member 221 will rotate back to a starting position by the pull of gravity. The position of the teeth 226 correspond to various modes of operation, such as a valet mode or an idle mode. Here, the arcuate pathway 228 is shown to be bent like a bow, but the present invention is not thereby limited.

In an exemplary embodiment, individual teeth 226 may be activated/extended individually in a particular mode only after the support rod 225 is fully moved along the arcuate pathway 228 in the obstructing member 221 such that the obstructing member 221 is in a fully obstructing position. Alternatively, the teeth 226 may be adapted to allow the support rod 225 movement along the arcuate pathway 228 in a direction such that the obstructing member 221 may be raised when the teeth 226 are activated/extended, but may lock the support rod 225 from moving along the arcuate pathway 228 in a direction such that the obstructing member 221 is lowered.

In FIG. 23, the vehicle power inhibiter system 230 works similarly to the vehicle power inhibiter system 220, however the locking mechanism differs. In the vehicle power inhibiter system 230, the support rod 231 is locked at a distal end on the base member 232 rather than the obstructing member 233. The base member 232 may additionally include teeth 234 in an arcuate pathway (or track) 238 of the distal end of the support rod 231 that lock the support rod 231 in place. Here, the distal end of the support rod 231 moves along the arcuate pathway 238 in the base member 232. The teeth 234 may individually be activated/extended in power on mode when the obstructing member 233 is raised, and deactivated/retracted upon loss of power or when the obstructing member 233 is lowered. When the teeth 234 are deactivated/retracted, the obstructing member 233 will rotate back to a starting position by the pull of gravity. The position of the teeth 234 correspond to various modes of operation, such as a valet mode or an idle mode. Here, the arcuate pathway 238 is shown to be bent like a bow, but the present invention is not thereby limited.

In an exemplary embodiment, individual teeth 234 may be activated/extended individually in a particular mode only after the support rod 231 is fully moved along the arcuate pathway 238 in the obstructing member 233 such that the obstructing member 233 is in a fully obstructing position. Alternatively, the teeth 234 may be adapted to allow the support rod 231 movement along the arcuate pathway 238 in a direction such that the obstructing member 233 may be raised when the teeth 234 are activated/extended, but may lock the support rod 231 from moving along the arcuate pathway 238 in a direction such that the obstructing member 233 is lowered.

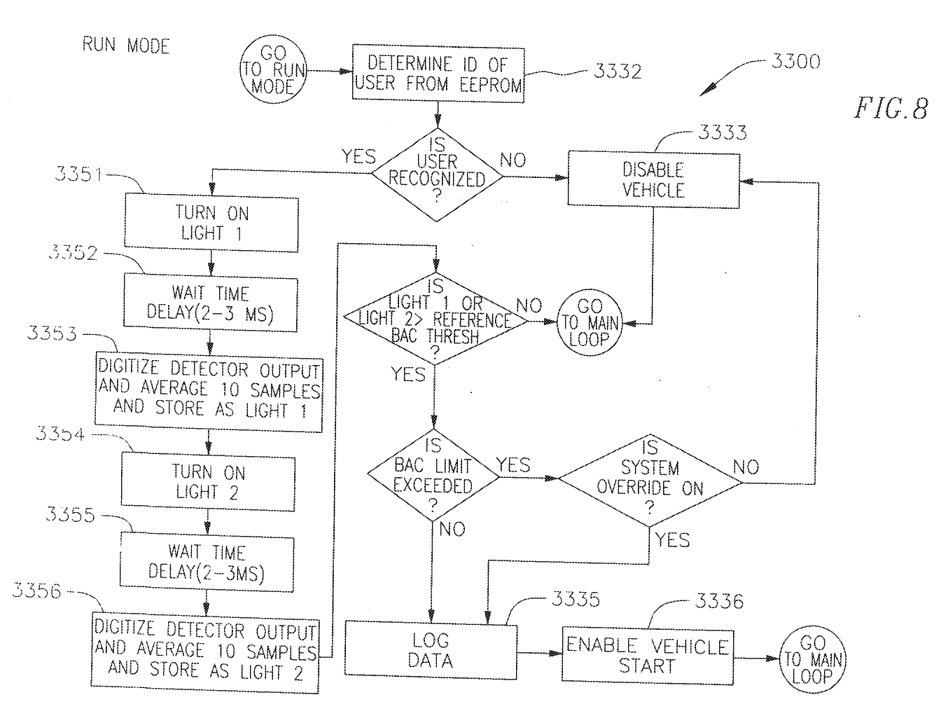

Referring back to FIG. 6, in the main loop 3000, if the valet switch 2020 is deactivated (e.g., not turned on), the system logics then poll the fingerprint sensor in block 3001 and determine if the finger is on the fingerprint sensor. Referring to FIGS. 6 and 8, if the finger of the user is on the fingerprint sensor, the system logics determine identification of the user from the persistent memory in block 3332.

The system logics then determine if the user is recognized. If the user is not recognized, the system logics disable the vehicle in block 3333. If the user is recognized, the logics start alcohol detection. That is, the system logics turn on a first light source in block 3351, provide a wait time delay (e.g., from about 2 to about 3 ms) in block 3352. In block 3353, the system logics then digitize the detector output sample, and average several samples (e.g., about 10 samples) to store this average first light source value as Light1. In addition, as shown in FIG. 8, the system logics turn on a second light source in block 3354, provide a wait time delay (e.g., from about 2 to about 3 ms) in block 3355. In block 3356, the system logics then digitize the detector output sample, and average several samples (e.g., about 10 samples) to store this average second light source value as Light2.

Then, as shown in FIG. 8, the system logic determines if the first light source value Light1 or the second light source value Light 2 is greater than a BAC threshold(s). If the BAC threshold(s) is not exceeded, the system logics then return to the main loop 3000. If the BAC threshold(s) is exceeded, the system logics then determined if the BAC limit is exceeded. If the BAC limit is exceeded, the system logics determine if the system override is on. If the system override is not on, the system logics move to block 3333 to disable the vehicle. By contrast, if the system override is on or the BAC limit has not been exceeded, the system logics log this data in block 3335, enable the vehicle to start in block 3336, and return to the main loop 3000.

In view of the foregoing, embodiments of the present inventions provide a method and system for inhibiting a power of a vehicle given to a third party (e.g., a valet).

In one embodiment of the present invention, a system for inhibiting a power of a vehicle given to a third party includes a system controller, a mode-indicating device coupled to the system controller, an authenticator coupled to the system controller, and a power inhibiting device coupled to the system controller and adapted to selectively inhibit the power of the vehicle. Here, the system controller is adapted to communicate a power restriction to the power inhibiting device to inhibit the power of the vehicle upon an activation of the mode-indicating device by an authenticated driver and until a deactivation of the mode-indicating device by the authenticated driver, and the system controller is further adapted to restrict the activation and the deactivation of the mode-indicating device unless the authenticated driver has been authenticated by the authenticator.

It should be appreciated from the above that the various structures and functions described herein may be incorporated into a variety of apparatuses (e.g., an imaging device, a monitoring device, etc.) and implemented in a variety of ways. Different embodiments of the imaging and/or monitoring devices may include a variety of hardware and software processing components. In some embodiments, hardware components such as processors, controllers, state machines and/or logic may be used to implement the described components or circuits. In some embodiments, code such as software or firmware executing on one or more processing devices may be used to implement one or more of the described operations or components.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A system for inhibiting power of a vehicle given to a third party, the system comprising:
a system controller;
a mode-indicating device coupled to the system controller;
an authenticator coupled to the system controller; and
a power inhibiting device coupled to the system controller and adapted to selectively inhibit the power of the vehicle,
wherein the system controller is adapted to communicate a power restriction signal to the power inhibiting device to mechanically inhibit the power of the vehicle upon an activation of the mode-indicating device by an authenticated driver and until a deactivation of the mode-indicating device by the authenticated driver, and
wherein the system controller is further adapted to restrict the activation and the deactivation of the mode-indicating device unless the driver has been authenticated by the authenticator.

2. The system of claim 1, wherein the power inhibiting device comprises:
a rotating cam plate fitted below an accelerator pedal of the vehicle and adapted to operate through a slot in a floor pan of the vehicle; and
a motor adapted to selectively drive the rotating cam plate to a first position to block a travel of the accelerator pedal to a first power level and a second position to unblock the travel of the accelerator pedal.

3. The system of claim 2, wherein the motor is further adapted to selectively drive the rotating cam plate to a third position to block a travel of the accelerator pedal to a second power level, and
wherein the second power level is higher in power than the first power level and lower in power than a full power level.

4. The system of claim 3, wherein the power inhibiting device comprises:
a first stop pin adapted to selectively move between a stopping position and a release position, the stopping position of the first stop pin being adapted to block the rotating cam plate from moving toward the second position from the first position; and
a second stop pin adapted to selectively move between a stopping position and a release position, the stopping position of the second stop pin being adapted to block the rotating cam plate from moving toward the second position from the third position.

5. The system of claim 2, wherein the power inhibiting device comprises a stop pin adapted to selectively move between a stopping position and a release position, the stopping position of the stop pin being adapted to block the rotating cam plate from moving toward the second position from the first position.

6. The system of claim 1, wherein the power inhibiting device comprises:
an inhibiting pin;
a split collet adapted to hold the inhibiting pin; and
a motor fitted to an underside of a floor pan of the vehicle and adapted to raise the inhibiting pin with the split collet through a hole in the floor pan of the vehicle to selectively block a travel of the accelerator pedal.

7. The system of claim 6, wherein the split collet is adapted to be disconnected from the inhibiting pin to unblock the travel of the accelerator pedal upon the deactivation of the mode-indicating device.

8. The system of claim 7, wherein the split collet comprises a solenoid actuated split threaded collet.

9. The system of claim 7, wherein the inhibiting pin has a multi-start thread.

10. The system of claim 7, wherein the inhibiting pin has a square thread.

11. The system of claim 7, wherein the inhibiting pin has a multi-start-square thread.

12. The system of claim 6, wherein the motor is adapted to turn the inhibiting pin to control a position of rise of the inhibiting pin and a power level of the vehicle.

13. The system of claim 1, wherein the power inhibiting device comprises:
a lever extended from a throttle arm and adapted to selectively limit a rotary travel of the throttle arm to limit an air supply to limit a demand to increase the power of the vehicle; and
a retractable pin adapted to selectively move between a stopping position and a release position, the stopping position of the retractable pin being adapted to limit a rotary travel of the lever.

14. The system of claim 13, wherein the power inhibiting device further comprises an overload protection device coupled between the throttle arm and an actuator cable adapted to drive the throttle arm.

15. The system of claim 14, wherein the overload protection device comprises an overload protection spring.

16. The system of claim 1, wherein the power inhibiting device comprises:
a lever extended from a throttle arm and adapted to selectively limit a rotary travel of the throttle arm to limit a demand to increase the power of the vehicle;
a first retractable pin adapted to selectively move between a stopping position and a release position, the stopping position of the first retractable pin being adapted to limit a rotary travel of the lever to a first lever position to limit the rotary travel of the throttle arm to a first throttle arm position to limit the demand to increase the power of the vehicle to a first power level; and
a second retractable pin adapted to selectively move between a stopping position and a release position, the stopping position of the second retractable pin being adapted to limit the rotary travel of the lever to a second lever position to limit the rotary travel of the throttle arm to a second throttle arm position to limit the demand to increase the power of the vehicle to a second power level.

17. The system of claim 15, wherein the second power level is higher in power than the first power level and lower in power than a full power level.

18. The system of claim 1, wherein the power inhibiting device comprises:
a control arm coupled to a linear lever of a fuel injection pump and adapted to selectively limit a travel of the linear lever to limit a fuel supply to limit a demand to increase the power of the vehicle; and
a retractable pin adapted to selectively move between a stopping position and a release position, the stopping position of the retractable pin being adapted to limit a travel of the control arm.

19. The system of claim 18, wherein the fuel injection pump is adapted to provide fuel to a diesel engine.

20. The system of claim 1, wherein the power inhibiting device comprises:
a control arm coupled to a linear lever of a fuel injection pump and adapted to selectively limit a travel of the linear lever to limit a demand to increase the power of the vehicle;
a first retractable pin adapted to selectively move between a stopping position and a release position, the stopping position of the first retractable pin being adapted to limit a travel of the control arm to a first arm position to limit the travel of the linear lever to a first lever position to limit the demand to increase the power of the vehicle to a first power level; and
a second retractable pin adapted to selectively move between a stopping position and a release position, the stopping position of the second retractable pin being adapted to limit the travel of the control arm to a second arm position to limit the travel of the linear lever to a second lever position to limit the demand to increase the power of the vehicle to a second power level.

21. A system for inhibiting power of a vehicle given to a third party, the system comprising:
a mode-indicating device; and
a power inhibiting device coupled to the mode-indicating device and adapted to selectively inhibit the power of the vehicle, the power inhibiting devices comprising:
a rotating cam plate fitted below an accelerator pedal of the vehicle and adapted to operate through a slot in a floor pan of the vehicle; and
a motor adapted to selectively drive the rotating cam plate to a first position to block a travel of the accelerator pedal to a first power level and a second position to unblock the travel of the accelerator pedal,
wherein the mode-indicating device is adapted to communicate a power restriction signal to the power inhibiting device to inhibit the power of the vehicle upon an activation of the mode-indicating device by a driver and until a deactivation of the mode-indicating device by the driver.

22. A system for inhibiting power of a vehicle given to a third party, the system comprising:
a mode-indicating device; and
a power inhibiting device coupled to the mode-indicating device and adapted to selectively inhibit the power of the vehicle, the power inhibiting devices comprising:
an inhibiting pin;
a split collet adapted to hold the inhibiting pin; and
a motor fitted to an underside of a floor pan of the vehicle and adapted to raise the inhibiting pin with the split collet through a hole in the floor pan of the vehicle to selectively block a travel of the accelerator pedal,
wherein the mode-indicating device is adapted to communicate a power restriction signal to the power inhibiting device to inhibit the power of the vehicle upon an activation of the mode-indicating device by a driver and until a deactivation of the mode-indicating device by the driver.

23. A system for inhibiting power of a vehicle given to a third party, the system comprising:
a mode-indicating device coupled to the system controller; and
a power inhibiting device coupled to the mode-indicating device and adapted to selectively inhibit the power of the vehicle, the power inhibiting device comprising:
a lever extended from a throttle arm and adapted to selectively limit a rotary travel of the throttle arm to limit an air supply to limit a demand to increase the power of the vehicle; and
a retractable pin adapted to selectively move between a stopping position and a release position, the stopping position of the retractable pin being adapted to limit a rotary travel of the lever,
wherein the mode-indicating device is adapted to communicate a power restriction signal to the power inhibiting device to inhibit the power of the vehicle upon an activation of the mode-indicating device by a driver and until a deactivation of the mode-indicating device by the driver.
